(19) United States
(12) Patent Application Publication
(10) Pub. No.: US 2025/0073646 A1
(43) Pub. Date: Mar. 6, 2025

(54) PRASEODYMIUM AND POLYAMINE FUNCTIONALIZED MESOPOROUS SILICA-BASED MEMBRANES

(71) Applicant: KING FAHD UNIVERSITY OF PETROLEUM AND MINERALS, Dhahran (SA)

(72) Inventors: Shehzada Muhammad Sajid JILLANI, Dhahran (SA); Abdul WAHEED, Dhahran (SA); Umair BAIG, Dhahran (SA); Isam H. ALJUNDI, Dhahran (SA)

(73) Assignee: KING FAHD UNIVERSITY OF PETROLEUM AND MINERALS, Dhahran (SA)

(21) Appl. No.: 18/457,707

(22) Filed: Aug. 29, 2023

(51) Int. Cl. B01D 69/14; B01D 61/02; B01D 69/02; B01D 69/12; B01D 71/02; B01D 71/56; C02F 1/44

(52) U.S. Cl. CPC B01D 69/148; B01D 61/027; B01D 69/02; B01D 69/1251; B01D 71/027; B01D 71/56; C02F 1/442; B01D 2325/02832; B01D 2325/06; B01D 2325/20; C02F 2101/12; C02F 2101/30

(57) ABSTRACT

A membrane including a support and an active layer. The active layer includes reacted units of a functionalized mesoporous silica, a first polyamine compound, and a polyfunctional acid halide compound. The first portion of Si atoms in the functionalized mesoporous silica are replaced by Pr atoms. A second portion of the Si atoms in the functionalized mesoporous silica are functionalized with a second polyamine compound. The Pr atoms, the second portion of Si atoms functionalized with the second polyamine compound, and non-modified Si atoms in the functionalized mesoporous silica are covalently bonded in an alternating sequence. The functionalized mesoporous silica, the first polyamine compound, and the polyfunctional acid halide compound are interfacially polymerized on the support to form the membrane.

### STATEMENT OF ACKNOWLEDGEMENT

Support provided by King Fahd University of Petroleum and Minerals (KFUPM) is gratefully acknowledged.

### BACKGROUND

### Technical Field

The present disclosure is directed to a nanofiltration membrane, and particularly to a praseodymium and polyamine functionalized mesoporous silica-based membranes for desalination.

### Description of the Related Prior Art

The description of the related prior art provided herein is for the purpose of generally presenting the context of the disclosure. Work of the presently named inventors, to the extent described in this background section, as well as aspects of the description which may not otherwise qualify as prior art at the time of filing, are neither expressly nor impliedly admitted as prior art against the present invention.

Sustainably providing clean and potable water is a challenge as large volumes of domestic, commercial, industrial, and municipal wastewater are discharged into natural water sources such as rivers, lakes, and oceans. Organic micropollutants (OMPs) such as drugs, antibiotics, cosmetics, dyes, and personal care products are also detected in ground and surface waters. The presence of these compounds in drinking water is a matter of concern as many of these are known to possess deleterious effects on human health. Several water treatment methodologies and techniques are known, including screening, filtration, dissolved air floatation, and sedimentation. In addition, there are chemical-based wastewater treatment methods such as flocculation, adsorption, chemisorption, ozonation, oxidative and reductive degradation of pollutants, precipitation, and ion exchange. These technologies require pre-treatment steps and have disadvantages, such as generating large quantities of waste which require proper disposal. Similarly, high energy costs and regeneration of materials such as ion-exchange resins are a challenge.

In comparison, membrane-based separation is advantageous because of its ease of availability for different types of feeds, ease of tuneability for matching the desired requirements, little footprint compared to large land areas required for air floatation, high permeate flux with clean water as output, rejection of a variety of species such as divalent and monovalent salts, dyes, drugs, pharmaceutical compounds and even the by-products generated during chemical degradation of pollutants. Hence, efforts have focused on developing novel and efficient membranes with enhanced performance.

Several techniques have been used for enhancing the performance of membranes, including developing an interlayer between the ultrafiltration support and polyamide active layers of the thin film composite (TFC) membranes. This can be achieved by incorporating a suitable additive in the membrane structure during interfacial polymerization (IP). Various additives have been explored to develop membranes with desired features and performance. Several nanomaterials such as carbon nanotubes (CNTs), mesoporous silica, graphene oxide nanosheets, metal-organic frameworks (MOFs), and carbon organic frameworks (COFs) have been incorporated into the

Among the nanomaterials, microporous or mesoporous silica such as MCM-41, has unique properties such as easy functionalization, homogenous hexagonal channel structure, large pore volume, large surface area, and excellent chemical and thermal stability. Due to these unique features, MCM-41 has found many applications, such as drug delivery, extraction, adsorption, sensors, and catalyst support. Due to its large surface area and porosity, MCM-41 has been used as a support with enhanced capacity for loading various catalysts and metal ions. Similarly, the large pore volume of MCM-41 also allows immobilization of organic ligands and metal ion complexes in the channels of MCM-41. Although various doping materials such as lanthanides have been decorated on MCM-41 based on mere physical or ionic interaction, most of these membranes prepared are unstable as the dopants can be washed out under high-pressure filtration experiments. Hence, there is a need for a strategy where metal ions can be covalently decorated in the MCM-41 framework to yield stable materials, which may eliminate or overcome the limitations above. Accordingly, an object of the present disclosure is to provide a membrane and a method of filtration with the membrane that has high stability, improved flux, and high removal efficiency.

### SUMMARY

In an exemplary embodiment, a membrane is described. The membrane includes a support and an active layer. The active layer includes reacted units of a functionalized mesoporous silica, a first polyamine compound, and a polyfunctional acid halide compound. A first portion of Si atoms in the functionalized mesoporous silica are replaced by Pr atoms. A second portion of the Si atoms in the functionalized mesoporous silica are functionalized with a second polyamine compound. The Pr atoms, the second portion of Si atoms functionalized with the second polyamine compound, and non-modified Si atoms in the functionalized mesoporous silica are covalently bonded in an alternating sequence. The functionalized mesoporous silica, the first polyamine compound, and the polyfunctional acid halide compound are interfacially polymerized on the support to form the membrane.

In some embodiments, the functionalized mesoporous silica is in a form of spherical particles with an average diameter of 500-600 nanometers (nm).

In some embodiments, the functionalized mesoporous silica has an average pore channel diameter of 2-5 nm.

In some embodiments, the functionalized mesoporous silica has a surface area of 200-250 meter square per gram (m² g⁻¹).

In some embodiments, the functionalized mesoporous silica includes C, Pr, N, O, and Si.

In some embodiments, 10-40% of the Si atoms are replaced by Pr, based on a total number of initial Si atoms in the functionalized mesoporous silica.

In some embodiments, 30-50% of the Si atoms are functionalized with the second polyamine compound, based on a total number of Si atoms in the functionalized mesoporous silica.

In some embodiments, the functionalized mesoporous silica is covalently bonded in the active layer. A primary or secondary amino group of the second polyamine compound in the functionalized mesoporous silica covalently bonds to a first acid halide group of the polyfunctional acid halide compound in the interfacial polymerization thereby forming an amide bond.

In some embodiments, a second acid halide group of the polyfunctional acid halide compound covalently bonds to a primary or secondary amino group of the first polyamine compound in the interfacial polymerization, thereby forming an amide bond.

In some embodiments, the functionalized mesoporous silica is distributed homogeneously over a surface of the active layer. Particles of the functionalized mesoporous silica are not agglomerated.

In some embodiments, the active layer has a ridge and valley morphology. At least a portion of the valleys are filled with the functionalized mesoporous silica.

In some embodiments, the active layer includes 0.01-1 wt. % of the functionalized mesoporous silica, based on total volume of an interfacial polymerization solution.

In some embodiments, the membrane has a mean square roughness (Rq) of 15-35 nm.

In some embodiments, the membrane has a water contact angle of 80-100°.

In some embodiments, the membrane has a permeate flux of 30-60 liter square meter per hour (L m⁻² h⁻¹) (LMH) at 25 bar.

In some embodiments, the first and second polyamine compounds are the same or different and are selected from compounds having 3-7 amine groups.

In some embodiments, the polyfunctional acid halide compound is an aromatic compound with 2-3 acyl chloride groups.

In some embodiments, the mesoporous silica is MCM-41.

In some embodiments, a method of removing a salt or an organic compound from an initial solution is described. The method includes passing the initial solution through the membrane to form a filtered solution. The filtered solution includes at least 80% less of the salt or the organic compound than the initial solution.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic representation of a synthesis route of Pr—(NH)₂NH₂-MCM-41, according to certain embodiments;

FIG. 2 is a schematic illustration of steps involved in a membrane fabrication through interfacial polymerization (IP), according to certain embodiments;

FIG. 3 is a schematic illustration of a reaction between Pr—(NH)₂NH₂-MCM-41, terephthaloyl chloride (TPC), and tetra-amine during the IP, according to certain embodiments;

FIG. 4A depicts a Fourier transform infrared spectroscopy (FTIR) spectrum of Pr—(NH)₂NH₂-MCM-41, according to certain embodiments;

FIG. 4B depicts a low-angle powder X-Ray diffraction (PXRD) of Pr—(NH)₂NH₂-MCM-41, according to certain embodiments;

FIG. 4C depicts a wide angle PXRD of Pr—(NH)₂NH₂-MCM-41, according to certain embodiments;

FIG. 5A depicts a Brunauer-Emmett-Teller (BET) isotherm of Pr—(NH)₂NH₂-MCM-41, according to certain embodiments;

FIG. 5B depicts a pore width of Pr—(NH)₂NH₂-MCM-41, according to certain embodiments;

FIG. 5C depicts a transmission electron microscopy (TEM) image of Pr—(NH)₂NH₂-MCM-41 at 500 nanometers (nm), according to certain embodiments;

FIG. 5D depicts a TEM image of Pr—(NH)₂NH₂-MCM-41 at 20 nm, according to certain embodiments;

FIG. 6A depicts an energy dispersive X-ray spectroscopic (EDX) selected area of Pr—(NH)₂NH₂-MCM-41, according to certain embodiments;

FIG. 6B depicts an EDX analysis of Pr—(NH)₂NH₂-MCM-41, according to certain embodiments;

FIGS. 6C-6G depict mapping analysis of Pr—(NH)₂NH₂-MCM-41 (0.05%), according to certain embodiments;

FIG. 7A depicts attenuated total reflectance-Fourier transform infrared spectroscopy (ATR-FTIR) spectra of Pr—(NH)₂NH₂-MCM-41 decorated active layer of the membranes, according to certain embodiments;

FIG. 7B depicts a fingerprint region of Pr—(NH)₂NH₂-MCM-41 decorated active layer of the membranes depicted in FIG. 7A, according to certain embodiments;

FIG. 8A depicts ATR-FTIR spectra of Pr—(NH)₂NH₂-MCM-41 decorated membrane and polysulfone (PSU)/polyester terephthalate (PET) support, according to certain embodiments;

FIG. 8B depicts a fingerprint region of Pr—(NH)₂NH₂-MCM-41 decorated membrane and PSU/PET support depicted in FIG. 8A, according to certain embodiments;

FIGS. 9A-9B depict atomic force microscopy (AFM) images of PSU/PET support, according to certain embodiments;

FIGS. 9C-9D depict AFM images of PA/0.025-Pr-MCM@PSU/PET, according to certain embodiments;

FIGS. 9E-9F depict AFM images of PA/0.050-Pr-MCM@PSU/PET, according to certain embodiments;

FIGS. 9G-9H depict AFM images of PA/0.100-Pr-MCM@PSU/PET decorated membrane and PSU/PET support, according to certain embodiments;

FIG. 10 depicts water contact angles (WCA) of PA/0.025-Pr-MCM@PSU/PET, PA/0.050-Pr-MCM@PSU/PET and PA/0.100-Pr-MCM@PSU/PET, according to certain embodiments;

FIGS. 11A-11C depict scanning electron microscope (SEM) micrographs of PSU/PET support, according to certain embodiments;

FIGS. 11D-11F depict SEM micrographs of PA/0.025-Pr-MCM@PSU/PET, according to certain embodiments;

FIGS. 11G-11I depict SEM micrographs of PA/0.050-Pr-MCM@PSU/PET, according to certain embodiments;

FIGS. 11J-11L depict SEM micrographs of PA/0.100-Pr-MCM@PSU/PET, according to certain embodiments;

FIG. 12A depicts selected areas for EDX of PSU/PET support, according to certain embodiments;

FIG. 12B depicts EDX analysis of PSU/PET support, according to certain embodiments;

FIG. 12C depicts selected areas for EDX of PA/0.025-Pr-MCM@PSU/PET, according to certain embodiments;

FIG. 12D depicts EDX analysis of PA/0.025-Pr-MCM@PSU/PET, according to certain embodiments;

FIG. 12E depicts selected areas for EDX of PA/0.050-Pr-MCM@PSU/PET, according to certain embodiments;

FIG. 12F depicts EDX analysis of PA/0.050-Pr-MCM@PSU/PET, according to certain embodiments;

FIG. 12G depicts selected areas for EDX of PA/0.100-Pr-MCM@PSU/PET, according to certain embodiments;

FIG. 12H depicts EDX analysis of PA/0.100-Pr-MCM@PSU/PET, according to certain embodiments;

FIGS. 13A-13F depict mapping analysis of PA/0.050-Pr-MCM@PSU/PET membrane as a representative membrane, according to certain embodiments;

FIG. 14A depicts an effect of pressure on permeate flux by PA/0.025-Pr-MCM@PSU/PET, PA/0.050-Pr-MCM@PSU/PET and PA/0.100-Pr-MCM@PSU/PET, according to certain embodiments;

FIG. 14B depicts salt rejection by PA/0.025-Pr-MCM@PSU/PET, PA/0.050-Pr-MCM@PSU/PET and PA/0.100-Pr-MCM@PSU/PET, according to certain embodiments;

FIG. 15A depicts structures of pharmaceuticals such as caffeine, sulfamethoxazole, amitriptyline, and loperamide HCl, according to certain embodiments; and

FIG. 15B depicts rejection of pharmaceuticals by PA/0.025-Pr-MCM@PSU/PET, PA/0.050-Pr-MCM@PSU/PET, and PA/0.100-Pr-MCM@PSU/PET, according to certain embodiments.

### DETAILED DESCRIPTION

When describing the present disclosure, the terms used are to be construed in accordance with the following definitions, unless a context dictates otherwise. Embodiments of the present invention will now be described more fully hereinafter with reference to the accompanying drawings wherever applicable, in which some, but not all embodiments of the disclosure are shown.

Further, as used herein, the use of singular includes plural and the words ‘a’, ‘an’ includes ‘one’ and means ‘at least one’ unless otherwise stated in this application.

Furthermore, the terms “approximately”, “approximate”, “about,” and similar terms generally refer to ranges that include the identified value within a margin of 20%, 10%, or preferably 5%, and any values therebetween.

Where a numerical limit or range is stated herein, the endpoints are included. Also, all values and subranges within a numerical limit or range are specifically included as if explicitly written out.

The use of the terms “include,” “includes”, “including,” “have,” “has,” or “having” should be generally understood as open-ended and non-limiting unless specifically stated otherwise.

As used herein, the term ‘amines’ refer to the compounds and functional groups that contain a basic nitrogen atom with a lone pair. Amines are formally derivatives of ammonia (NH₃), where one or more hydrogen atoms have been replaced by a substituent such as an alkyl or aryl group (these may respectively be called alkylamines and arylamines; amines in which both types of substituent are attached to one nitrogen atom may be called alkylarylamines). Amines may include amino acids, biogenic amines, trimethylamine, and aniline. Inorganic derivatives of ammonia are also called amines, such as monochloramine (NClH₂).

As used herein, the term ‘amide bond’ refers to R—C(═O)—NR′R″, where R, R′, and R″ represent any group.

The term ‘aromatic compounds’ or ‘aromatic rings’, as used herein, refers to hydrocarbon rings that, by the theory of Hückel, have a cyclic, delocalized (4n+2) pi-electron system. Non-limiting examples of aromatic compounds include benzene, benzene derivatives, compounds having at least one benzene ring in their chemical structure, toluene, ethylbenzene, p-xylene, m-xylene, mesitylene, durene, 2-phenylhexane, biphenyl, phenol, aniline, nitrobenzene, and the like.

As used herein, the term “membrane” refers to a porous structure capable of separating components of a homogeneous or heterogeneous fluid. In particular, “pores” in the sense of the present disclosure indicate voids allowing fluid communication between different sides of the structure. More particular in use when a homogeneous or heterogeneous fluid is passed through the membrane, some components of the fluid can pass through the pores of the membrane into a “permeate stream”, some components of the fluid can be retained by the membrane and can thus accumulate in a “retentate” and/or some components of the fluid can be rejected by the membrane into a “rejection stream”. Membranes can be of various thicknesses, with homogeneous or heterogeneous structures. Membranes can be in the form of flat sheets or bundles of hollow fibers. Membranes can also be in various configurations, including but not limited to spiral wound, tubular, hollow fiber, and other configurations identifiable to a skilled person upon reading the present disclosure. Membranes can also be classified according to their pore diameter. Membranes can be neutral or charged, and particle transport can be active or passive. The latter can be facilitated by pressure, concentration, and chemical or electrical gradients of the membrane process.

Aspects of the present disclosure are directed toward nanofiltration membranes fabricated by decorating the membranes with a praseodymium doped mesoporous silica. The praseodymium doped mesoporous silica is covalently bonded to the membrane. Subsequently, the fabricated membranes are used for removing divalent (CaCl₂, MgCl₂, Na₂SO₄, MgSO₄) ions, monovalent (NaCl) ions and pharmaceuticals (caffeine, sulfamethoxazole, amitriptyline, loperamide) from water sources.

In some embodiments, a membrane is described. The membrane is fabricated by incorporating an active layer on support. In some embodiments, the active layer covers at least 50%, preferably 60%, more preferably 80%, and yet more preferably more than 95% of the surface of the support. In some embodiments, the active layer has a thickness of 100 to 500 nm, preferably in the range of 110-490, preferably 120-480, preferably 130-470, preferably 140-460, preferably 150-450, preferably 160-440, preferably 170-430, preferably 180-420, preferably 190-410, preferably 200-400 nm, on the support.

The support should possess good mechanical and thermal properties. Also, the support should demonstrate high resistance to chemicals such as aromatic hydrocarbons, ketones, ethers, and esters. The support includes a polymer component configured to strengthen the membrane structure. Suitable polymers to be included in support layers comprise, for example, poly(vinylidene) fluoride (PVDF), poly(tetrafluoroethylene) (PTFE), poly(acrylonitrile) (PAN), poly(methyl methacrylate) (PMMA), poly(methacrylic acid) (PMAA), poly(acrylic acid) (PAA), poly(vinyl methyl ketone), and poly(ethylene terephthalate) (PET), polysulfone (PS), polyethersulfone (PES), poly(ether sulfone) (PSf), polyacrylonitrile (PAN), polypropylene (PP), polyimide (PI), and poly(arylene ether nitrile ketone) (PPENK), which can used alone or in combination. In some embodiments, the support includes PSf and PET. To prepare the support (PSf/PET), the PSf and the PET were mixed in various weight ratios to obtain the support with desired chemical, mechanical, and thermal properties. Although the description herein refers to the use of PSf/PET support, it may be understood by a person skilled in the art that other polymeric supports may be used as well, albeit with a few variations, as may be obvious to a person skilled in the art. The support may be prepared by any of the conventional methods known in the art-for example, the phase inversion method or the electrostatic spinning method. In a preferred embodiment, the PSf/PET support is prepared by the phase inversion method.

In some embodiments, the active layer includes mesoporous silica. Mesoporous silica is a form of silica that is characterized by its mesoporous structure, that is, having pores that range from 2 nm to 50 nm in diameter. In some embodiments, the mesoporous silica is selected from ZSM-5, ZSM-11, MCM-48, MCM-41, MCM-22, SUZ-4, and SBA-15. In some embodiments, the mesoporous silica may include SBA-15, HMM-33, and TUD-1. In a preferred embodiment, the mesoporous silica has a hierarchical structure of Mobil Composition of Matter (MCM)-41. MCM-41 has unique properties such as easy functionalization, homogenous hexagonal channel structure, large pore volume, large surface area, and excellent chemical and thermal stability. MCM-41 is made up of repeating units of SiO₄.

In a preferred embodiment, the mesoporous silica is functionalized, thereby forming functionalized mesoporous silica. The mesoporous silica can be functionalized by 1) substituting a portion of the Si atoms in the structure with another element and/or 2) bonding a compound to the Si.

As to option 1, in some embodiments, Si atoms in the functionalized mesoporous silica are replaced by chemical methods known in the art. In some embodiments, a first portion of Si atoms in the functionalized mesoporous silica are replaced by a lanthanide. Lanthanides have a large coordination potential owing to their large atomic size and, consequently, large coordination numbers. In some embodiments, the lanthanide is selected from the group consisting of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), and lutetium (Lu).

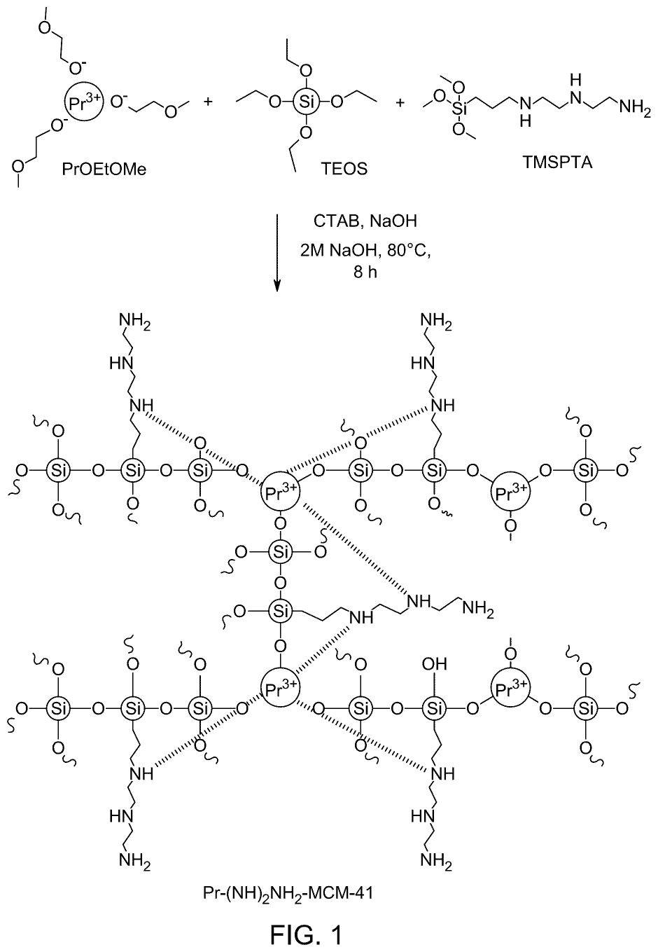

In a preferred embodiment, the lanthanide is Pr. Pr is a soft, silvery, metallic element in two +3 and +4 general oxidation states. The oxides of Pr have different phases which depend on oxygen availability in the ambient environment. Generally, praseodymium oxide has the formula of PₙO₂ₙ₋₁ (n=1,2, 3, 4, 5, 6, 7, 8, 9, or 10). The oxide coverts from Pr₂O₃ to PrO₂ with a decrease in temperature and an increase in oxygen content. The Pr6On1 is considered a mixed oxide of 4PrO₂ and Pr₂O₃, contains oxygen vacancies and has a high hole and oxygen ion conductivity. In some embodiments, a first portion of Si atoms in the functionalized mesoporous silica are replaced by Pr atoms. Specifically, about 10%, about 20%, and about 30% of the Si atoms are replaced by Pr, based on the total number of initial Si atoms in the mesoporous silica. In some embodiments, up to about 40% of the Si atoms are replaced by Pr, based on the total number of initial Si atoms in the mesoporous silica. Following the replacement of a portion of the Si atoms with the Pr atoms, the mesoporous silica is labeled as functionalized mesoporous silica. In some embodiments, the Pr atoms are spaced evenly throughout the functionalized mesoporous silica. For example, if 20% of the silica atoms are replaced by Pr, then every 5^{th} Si atom is a Pr. In the functionalized mesoporous silica, the Pr atoms are bound to three oxygen atoms, thereby resulting in Pr with a 3+ charge, which allows for coordination of the Pr to three other atoms in the functionalized mesoporous silica. An embodiment of this is shown in FIG. 1. The substitution of the Pr which bonds to three oxygen atoms over the silicon which was bonded to four oxygen atoms thereby changes the overall structure of the material as will be discussed later.

As to the functionalization option 2) in some embodiments, a second portion of the Si atoms in the functionalized mesoporous silica is functionalized with a compound. The first portion replaced by Pr and the second portion functionalized with a compound are different Si atoms. In other words, the substituted Pr atoms are not functionalized with the compound. Specifically, about 30%, about 40% of the Si atoms in the functionalized mesoporous silica are functionalized with the compound, based on the total number of Si atoms in the functionalized mesoporous silica. In some embodiments, about 50% of the Si atoms in the functionalized mesoporous silica are functionalized with the compound, based on a total number of Si atoms in the functionalized mesoporous silica.

In a preferred embodiment, the compound comprises an S, O, or N. In an embodiment, the compound is a linear chain having 2-30 atoms, preferably 3, 4, 5, 6, 7, 8, 9, 10, 11, 12, 13, 14, 15, 16, 17, 18, 19, 20, 21, 22, 23, 24, 25, 26, 27, 28, or 29 atoms. In some embodiments, the compound is a polyamine and has 3-7 amine groups, preferably 4, 5, or 6 amine groups. In a most preferred embodiment, the compound is a linear polyamine with three amine groups. The compound is also referred to throughout as the second polyamine compound.

In some embodiments, a portion of the silica atoms are not modified, herein referred to as non-modified Si atoms. The Pr atoms, the second portion of Si atoms functionalized with the second polyamine compound, and non-modified Si atoms in the functionalized mesoporous silica are covalently bonded in an alternating sequence. In other words, there are not two non-modified Si atoms next to one another, there are not two Pr atoms next to one another, and there are not two Si atoms functionalized with the second polyamine compound next to one another. In the structure, the Pr³⁺ can interact with the lone pair on a N in the second polyamine compound. In a preferred embodiment, the Pr³⁺ interacts with the lone pair on the N in three separate second polyamine compounds. An embodiment, of this structure is shown in FIG. 1. One of ordinary skill in the art would recognize that this structure would be modified based on the mesoporous silica, lanthanide atom, and second polyamine compound used.

The shape of the functionalized mesoporous silica may include, but is not limited to spherical, rod, cubic, needle, triangular, octahedral, flower, or platelet shaped. In a preferred embodiment, the functionalized mesoporous silica is in a form of spherical particles with an average diameter of about 500 nanometers (nm), about 510 nm, about 520 nm, about 530 nm, about 540 nm, about 550 nm, about 560 nm, about 570 nm, about 580 nm, about 590 nm. The functionalized mesoporous silica is in a form of spherical particles with an average diameter up to about 600 nm.

The functionalized mesoporous silica has an average pore channel diameter of about 2 nm, about 2.5 nm, about 3 nm, and 4 nm. The functionalized mesoporous silica has an average pore channel diameter of up to about 5 nm. The functionalized mesoporous silica has a surface area of about 200-meter square per gram (m² g⁻¹), about 210 m² g⁻¹, about 220 m² g⁻¹, about 230 m² g⁻¹, about 240 m² g⁻¹. The functionalized mesoporous silica has a surface area of about 250 m² g⁻¹, preferably 216 m² g⁻¹. In some embodiments, the functionalized mesoporous silica includes C, Pr, N, O, and Si. In some embodiments, the functionalized mesoporous silica consists of C, Pr, N, O, and Si.

The active layer further includes a first polyamine compound. In some embodiments, the first polyamine compound and the second polyamine compound are the same. In some embodiments, the first polyamine compound and the second polyamine compound are different and are selected from compounds having 3-7 amine groups. In a preferred embodiment, the first and second polyamine compounds are different. In an embodiment, the first polyamine compound is a linear chain having 2-30 atoms, preferably 3, 4, 5, 6, 7, 8, 9, 10, 11, 12, 13, 14, 15, 16, 17, 18, 19, 20, 21, 22, 23, 24, 25, 26, 27, 28, or 29 atoms. In some embodiments, the first polyamine compound is a polyamine and has 3-7 amine groups, preferably 4, 5, or 6 amine groups. In a most preferred embodiment, the first polyamine compound is a linear polyamine with four amine groups.

Furthermore, the active layer includes a polyfunctional acid halide compound. The polyfunctional acid halide compound is an aromatic compound with 2-3 acyl chloride groups. In a preferred embodiment, the polyfunctional acid halide compound is terephthalyol chloride.

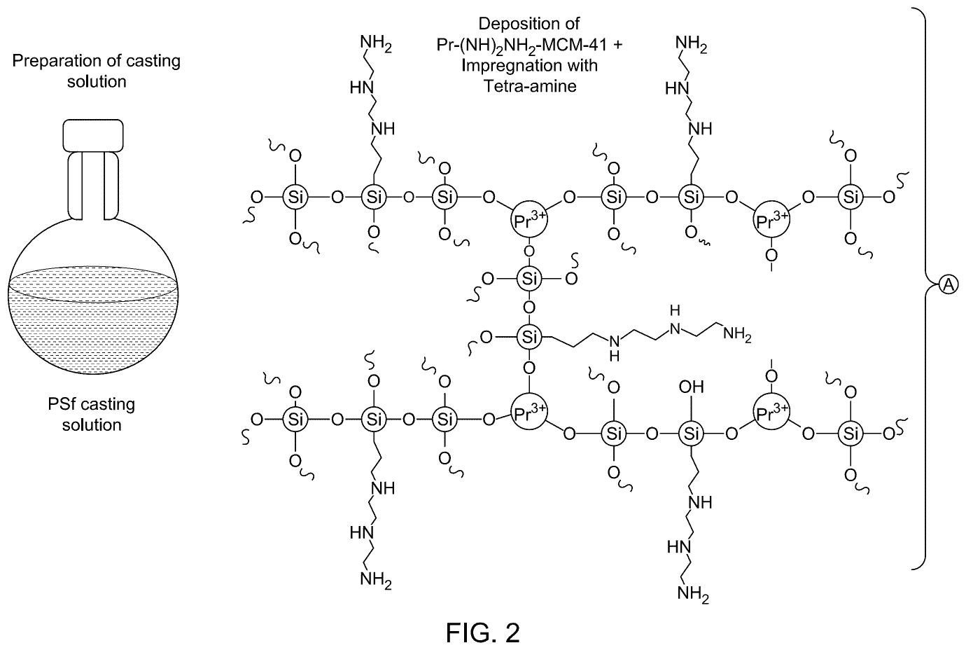

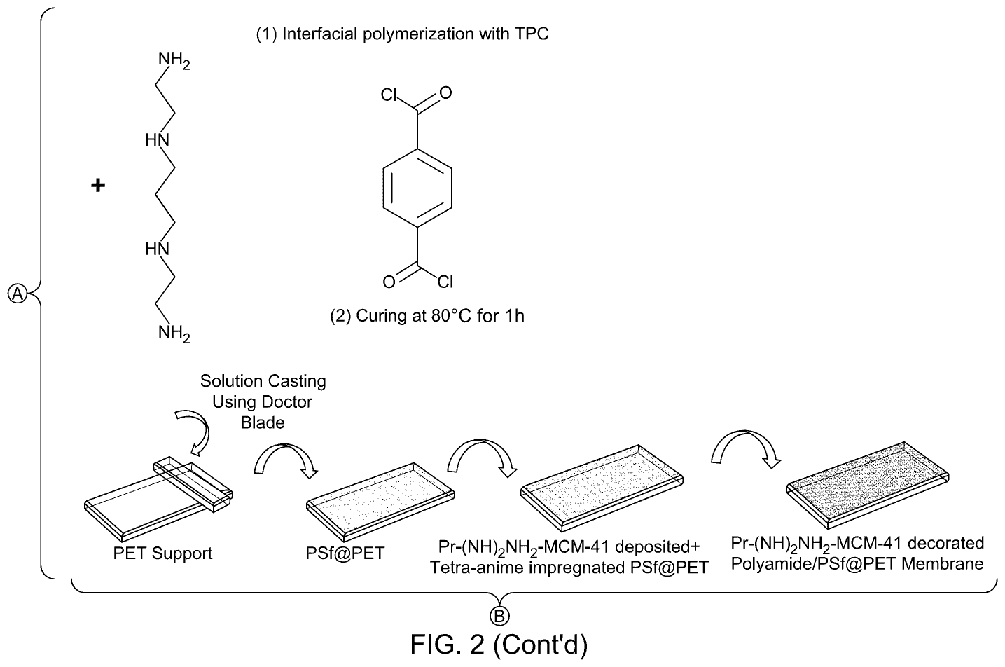

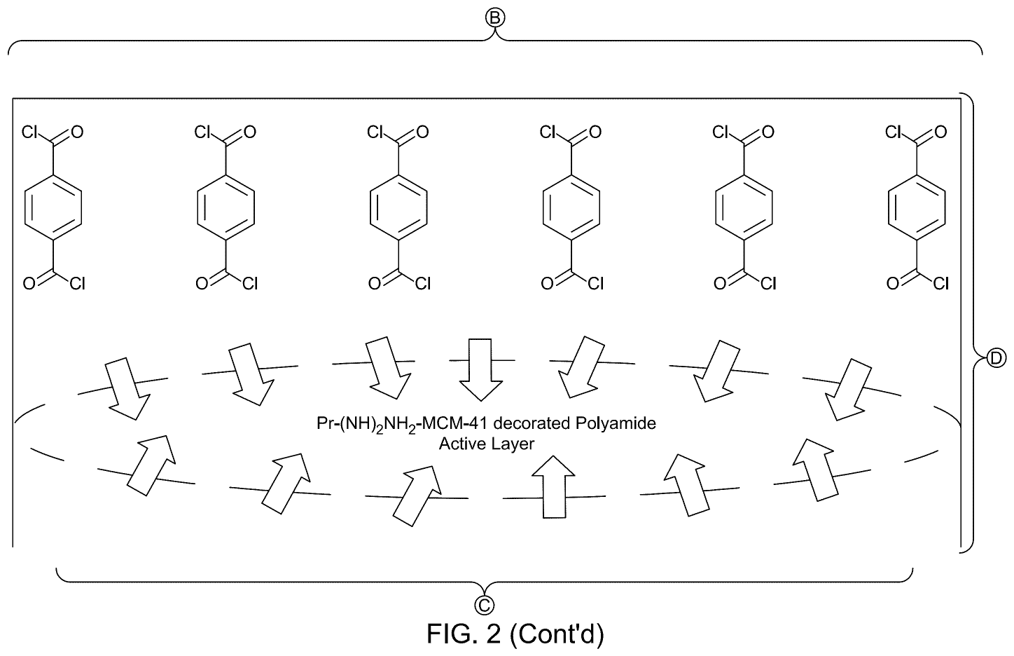

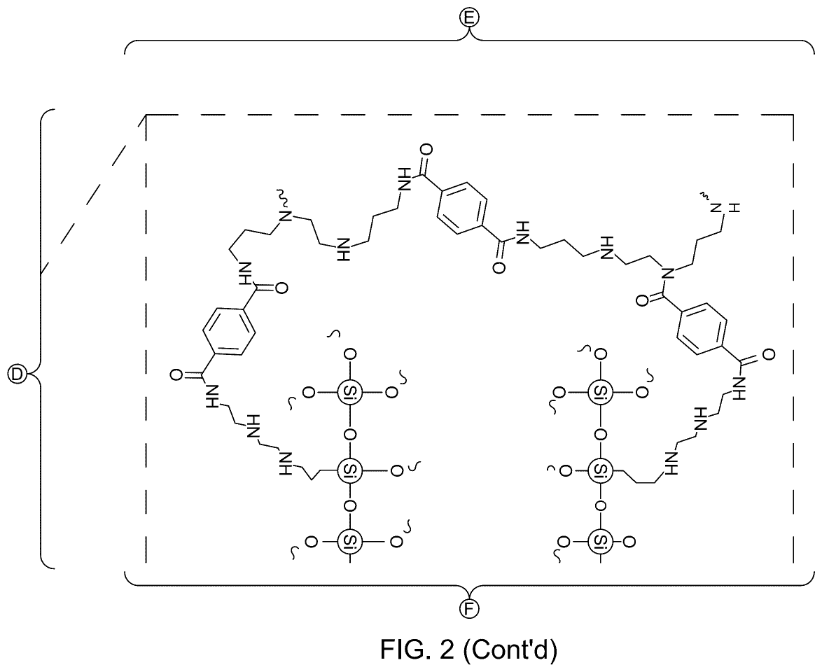

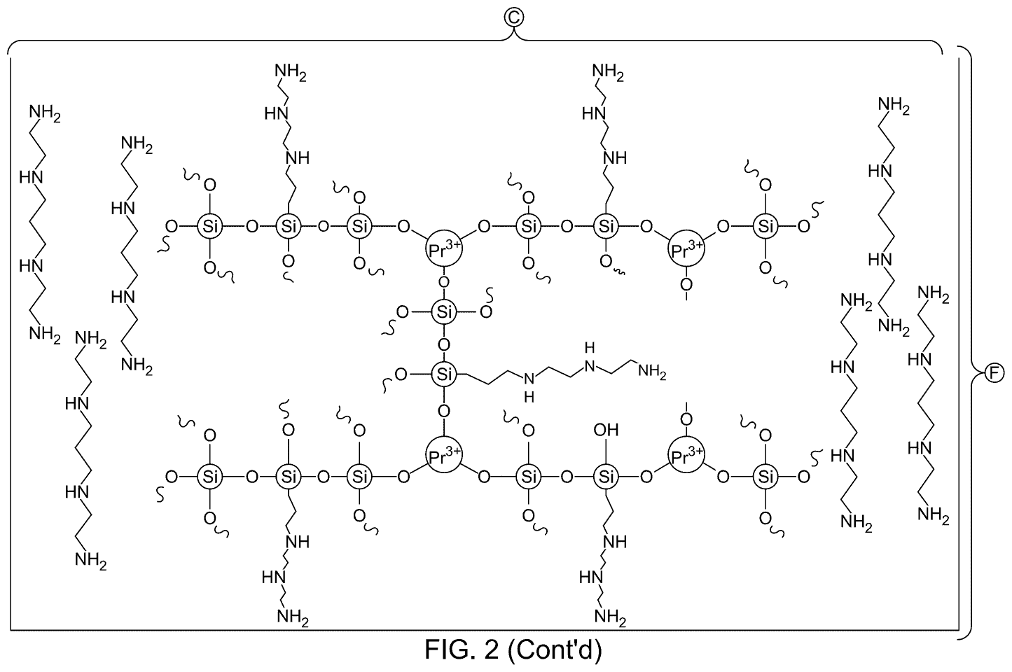

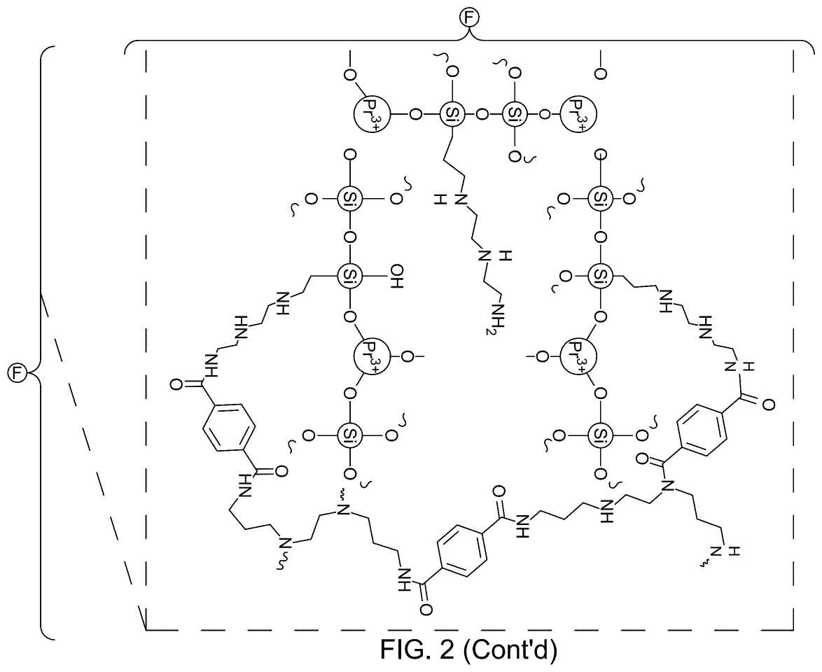

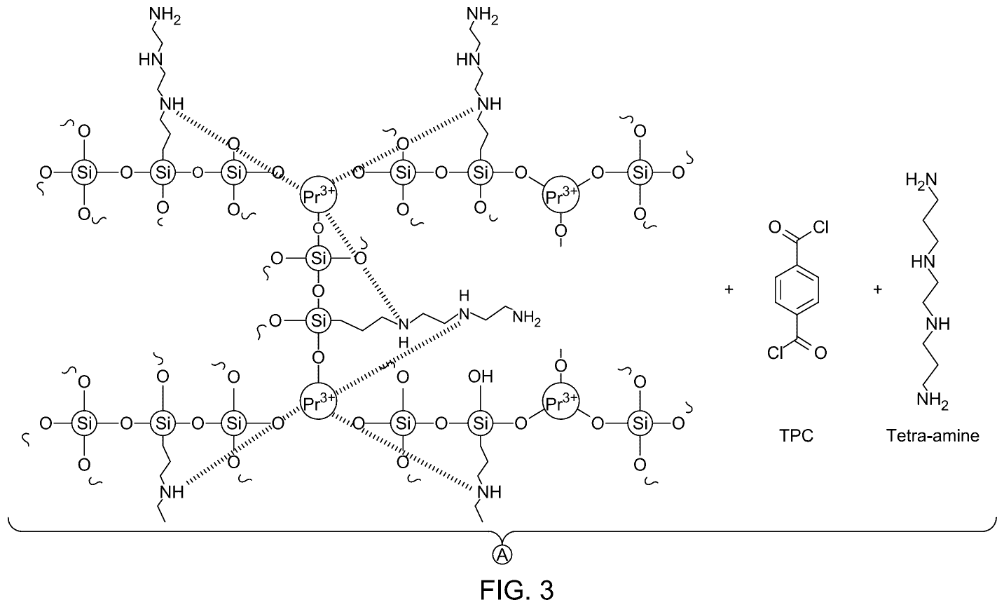

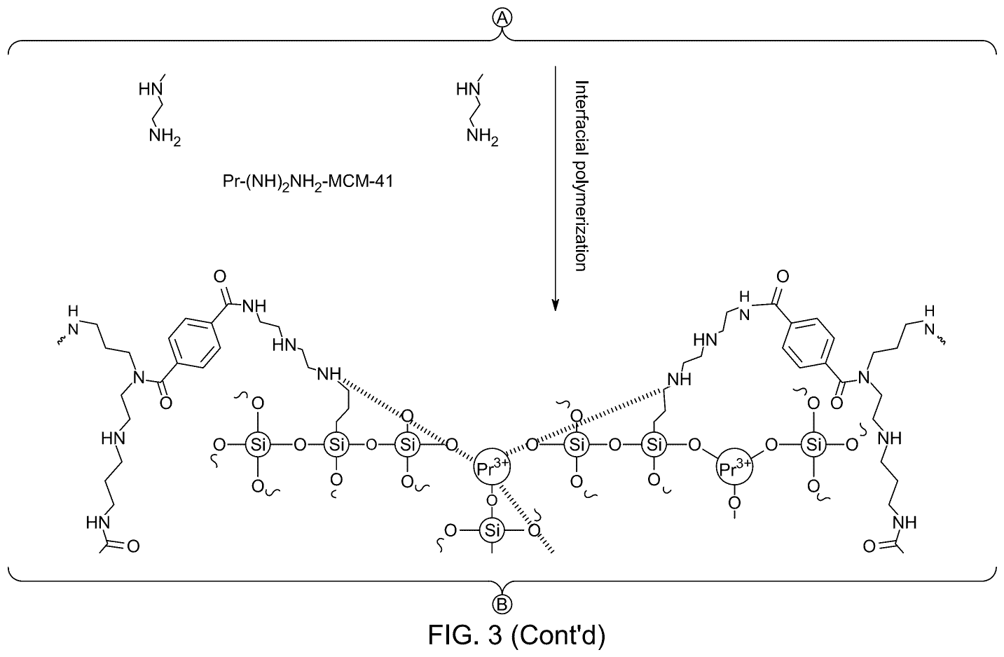

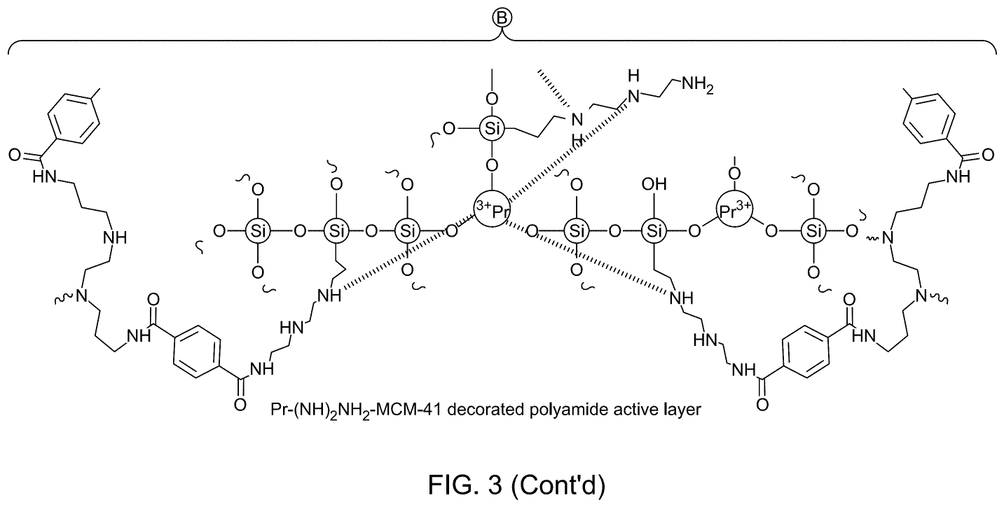

In the active layer, the functionalized mesoporous silica, the first polyamine compound, and the polyfunctional acid halide compound are interfacially polymerized on the support. In some embodiments, the functionalized mesoporous silica is covalently bonded in the active layer. For example, a primary or secondary amino group of the second polyamine compound in the functionalized mesoporous silica covalently bonds to a first acid halide group of the polyfunctional acid halide compound in the interfacial polymerization thereby forming an amide bond. At the same time, in some embodiments, a second acid halide group of the polyfunctional acid halide compound covalently binds to a primary or secondary amino group of the first polyamine compound in the interfacial polymerization thereby forming an amide bond. This forms a covalently bonded and interconnected structure of the polyfunctional acid halide compound, the first polyamine compound, and functionalized mesoporous silica. An embodiment, of the bonding is shown in FIGS. 2 and 3. One of ordinary skill in the art would recognize that this structure would be modified based on the polyfunctional acid halide compound, the first polyamine compound, and functionalized mesoporous silica used.

In some embodiments, the active layer includes about 0.01 wt. %, about 0.02 wt. %, about 0.03 wt. %, about 0.04 wt. %, about 0.05 wt. %, about 0.06 wt. %, about 0.07 wt. %, about 0.08 wt. %, about 0.09 wt. %, of the functionalized mesoporous silica, based on the total volume of an interfacial polymerization solution. In some embodiments, the active layer includes up to about 1 wt. %, of the functionalized mesoporous silica, based on total volume of an interfacial polymerization solution.

In an embodiment, the support is deposited partially or wholly with reacted units of at least one layer of the functionalized mesoporous silica, the first polyamine compound, and the polyfunctional acid halide compound in a uniform and continuous manner. In a preferred embodiment, the functionalized mesoporous silica, the first polyamine compound, and the polyfunctional acid halide compound form a continuous layer on the support. In an embodiment, the functionalized mesoporous silica, the first polyamine compound, and the polyfunctional acid halide compound form a monolayer on the support. In another embodiment, the functionalized mesoporous silica, the first polyamine compound, and the polyfunctional acid halide compound may include more than a single layer on the support.

In some embodiments, the covalently bonded functionalized mesoporous silica is distributed homogeneously over a surface of the active layer. The particles of the functionalized mesoporous silica are not agglomerated. In some embodiments, the active layer has a ridge and valley morphology. At least a portion of the valleys are filled with the functionalized mesoporous silica. The ridge and valley structure creates a rough surface on the active layer which varies based on the amount of the functionalized mesoporous silica included in the active layer. In some embodiments, the membrane has a mean square roughness (Rq) of about 15 nm, about 16 nm, about 17 nm, about 18 nm, about 19 nm, about 20 nm, about 21 nm, about 22 nm, about 23 nm, about 24 nm, about 25 nm, about 26 nm, about 27 nm, about 28 nm, about 29 nm, about 30, about 31, about 32, about 33, and about 34 nm. The membrane has a mean square roughness (Rq) up to about 35 nm.

In some embodiments, the membrane has a water contact angle of about 80°, about 81°,about 82°, about 83°, about 84°, about 85°, about 86°, about 87°, about 88°, about 89°, about 90°, about 91°, about 92°, about 93°, about 94°, about 95°, about 96°, about 97°, about 98°, and about 99°. In some embodiments, the membrane has a water contact angle up to about 100°, more preferably 95°, more preferably 90°. and yet more preferably 85°. As used herein, the term ‘contact angle’ is the angle between a liquid surface and a solid surface where they meet. More specifically, it is the angle between the surface tangent on the liquid-vapor interface and the tangent on the solid-liquid interface at their intersection. Generally, if the water contact angle is smaller than 90°, the solid surface is considered hydrophilic, and if the water contact angle is larger than 90°, the solid surface is considered hydrophobic.

In some embodiments, the membrane has a permeate flux of about 30-liter square meter per hour (L m⁻² h⁻¹) (LMH), about 31 L m⁻² h⁻¹, about 32 L m⁻² h⁻¹, about 33 L m⁻² h⁻¹, about 34 L m⁻² h⁻¹, about 35 L m⁻² h⁻¹, about 36 L m⁻² h⁻¹, about 37 L m⁻² h⁻¹, about 38 L m⁻² h⁻¹, about 39 L m⁻² h⁻¹, about 40 L m⁻² h⁻¹, about 41 L m⁻² h⁻¹, about 42 L m⁻² h⁻¹, about 43 L m⁻² h⁻¹, about 44 L m⁻² h⁻¹, about 45 L m⁻² h⁻¹, about 46 L m⁻² h⁻¹, about 47 L m⁻² h⁻¹, about 48 L m⁻² h⁻¹, about 49 L m⁻² h⁻¹, about 50 L m⁻² h⁻¹, about 51 L m⁻² h⁻¹, about 52 L m⁻² h⁻¹, about 53 L m⁻² h⁻¹, about 54 L m⁻² h⁻¹, about 55 L m⁻² h⁻¹, about 56 L m⁻² h⁻¹, about 57 L m⁻² h⁻¹, about 58 L m⁻² h⁻¹, and about 59 L m⁻² h⁻¹, at 25 bar. In some embodiments, the membrane has a permeate flux up to about 60 L m⁻² h⁻¹ at 25 bar, preferably 56 L m⁻² h⁻¹. In some embodiments, a single membrane may be used. In some embodiments, a plurality of similar membranes may be used.

According to an implementation of the present disclosure, a method of removing a salt or an organic compound from an initial solution is described. In an embodiment, the salt is an ionic salt. Suitable examples of ionic salt include MgCl₂, CaCl₂, MgSO₄, Na₂SO₄, and NaCl. In some other embodiments, the organic compound is a pharmaceutically active compound.

Pharmaceutically active compounds are a class of emerging environmental contaminants widely being used in human and veterinary medicine. Domestic disposal and hospital sewage discharge are the primary source of release of these substances and their metabolites into the environment. Suitable examples of pharmaceutically active compounds include cetaminophen, metoprolol, caffeine, antipyrine, sulfamethoxazole, flumequine, ketorolac, atrazine, isoproturon, 2-hydroxybiphenyl, diclofenac, amitriptyline, and loperamide. Certain other examples include, analgesics (for example, propoxyphene); anticonvulsants (for example: phenytoin); anti-depressants (for example, fluoxetine (Prozac), sertraline (Zoloft), amitriptyline, protriptyline, trimipramine maleate, nortriptyline, desipramine, imipramine, doxepin, nordoxepin, paroxetine); anti-inflammatory (for example, methyprednisolone, prednisone); hormones (for example, equilin, 17β-estradiol, estrone, 17α-ethynyl estradiol, medroxyprogesterone, megestrol acetate, mestranol, progesterone, norethindrone, norethynodrel, norgestrel, cholesterol); antibiotics (for example, norfloxacin, lincomycin, oxytetracycline HCl, ciprofloxacin, ofloxacin, trimethoprim, penicillin G. ½-benzathine salt, sulfamethoxazole, penicillin V potassium salt, tylosin tartrate). In a preferred embodiment, the organic compounds are pharmaceutically active compounds selected from caffeine, sulfamethoxazole, amitriptyline, loperamide, or a mixture thereof.

The method includes passing the initial solution through the membrane to form a filtered solution. The filtered solution includes at least 80% less, preferably 85%, 90%, 95%, or 100% less of the salt or the organic compound than the initial solution.

While not wishing to be bound to a single theory, it is thought that the covalent bonding of the functionalized mesoporous silica in the membrane active layer during the interfacial polymerization causes the particles to stay in place and form well-defined nanochannels and prevents undesired defects and inhomogeneity. As the amount of the functionalized mesoporous silica increases the morphology of the active layer changes, as the functionalized mesoporous silica fills the valleys creating a smoother surface, which lowers the mass transfer resistance to the salts and permeating water through the membrane. Therefore, the balance of the properties of the active layer results in an improved permeate flux, and enhanced rejection of pollutants.

### EXAMPLES

The following examples demonstrate a membrane as described herein. The examples are provided solely for illustration and are not to be construed as limitations of the present disclosure, as many variations thereof are possible without departing from the spirit and scope of the present disclosure.

### Example 1: Materials

Polysulfone (PS), N,N′-bis (3-aminopropyl) ethylenediamine (tetra-amine, TA), cetyltrimethylammonium bromide (CTAB), tetraethyl orthosilicate (TEOS), sodium hydroxide (NaOH), terephthalyol chloride (TPC), triethylamine (TEA), and were purchased from Sigma Aldrich, USA. The ethanol and hydrochloric acid (HCl) were purchased from Merck, Germany. Praseodymium methoxyethoxide (PrOMeEtO)) and N1-(3-trimethoxy silylpropyl) diethylenetriamine (TMSPTA) were purchased from Gelest USA. For the filtration test, different salts (MgCl₂, CaCl₂, MgSO₄, Na₂SO₄, NaCl) and pharmaceutically active compounds (caffeine, sulfamethoxazole, amitriptyline, loperamide) were also bought from Sigma.

### Example 2: Characterization Methods

The material was characterized using Powdered X-Ray Diffraction (PXRD) Ultima IV Rigaku, Transmission Electron Microscopy (TEM) (JEM2100F (manufactured by JEOL, Musashino Akishima, Tokyo, 196-0021 Japan). Quantachrome: Autosorb (ASIQCU01000-6, USA) and scanning electron microscope (JSM6610LV (manufactured by JEOL, Musashino Akishima, Tokyo, 196-0021 Japan). The material, active layer, and membranes were evaluated for the functional group vibrations using attenuated total reflectance-Fourier-transform infrared spectroscopy (Smart iTR NICOLET iS10 (manufactured by Thermo scientific™, 168 Third Avenue, Waltham, MA, USA 02451)). The membranes' surface morphology, roughness, and hydrophillicity were characterized using a scanning electron microscope (JSM6610LV, (manufactured by JEOL, Musashino Akishima, Tokyo, 196-0021 Japan)), atomic force microscope (Agilent 550, Netherland) and water contact angle (KRUSS DSA25) respectively. The solutions of salt and pharmaceutical were tested using a conductivity meter (Ultrameter II, Hanna) and JASCO V-750 UV-Vis spectrophotometer, respectively.

### Example 3: Synthesis of Pr—(NH)₂NH₂-MCM-41

The Pr—(NH)₂NH₂-MCM-41 was synthesized by dissolving 0.5 grams (g) of CTAB in 480 milliliters (mL) DI water and 7.0 mL of 2 molar (M) NaOH. This solution was stirred at 80° C. for 30 minutes. Later, TEOS (9.4 g) was added slowly to the stirring mixture, and stirring was continued for an additional 30 minutes. Subsequently, triamine TMSPTA (20% to TEOS molar ratio) and PrOMeEtO (20% to TEOS molar ratio) were added under continuous stirring for 1.5 hours. The precipitated product was centrifuged, washed multiple times with ethanol/HCl (100:1, V/V) mixture to remove CTAB, and dried at 90° C. in the oven. The functionalized mesoporous silica synthesized by the method of the present disclosure by in-situ chemical bonding of praseodymium oxide and triamine functionalized silane to mesoporous silica MCM-41 network is denoted as Pr—(NH)₂NH₂-MCM-41 as shown in FIG. 1.

### Example 4: Membrane Fabrication

Three different membranes were fabricated by altering the amount (0.025% wt./v, 0.05% wt./v, 0.1% wt./v) of Pr—(NH)₂NH₂-MCM-41 in the active layers of membranes through interfacial polymerization (IP). Three aqueous amine solutions were prepared by dissolving 2% wt./v of TA and 4% TEA and different amounts (0.025, 0.05, and 0.1%) of Pr—(NH)₂NH₂-MCM-41. The aqueous solution was thoroughly homogenized using a probe sonicator. Separately, a n-hexane solution was prepared by dissolving 0.2% wt./v TPC crosslinker.

Polysulfone (Psf) was cast on polyester terephthalate (PET) using wet phase inversion methodology to fabricate ultrafiltration support of the nanofiltration membranes. Following wet phase inversion, the Psf/PET supports were dipped in a SDS solution overnight. For IP, the Psf/PET supports were tapped onto the glass surface and dipped separately into three prepared aqueous amine solutions for 10 minutes while shaking in a see-saw direction. Upon amine impregnation and loading of Pr—(NH)₂NH₂-MCM-41, the Psf/PET supports were removed from aqueous amine solutions, and excess aqueous amine solution was removed using a rubber roller. Next, the amine-impregnated and Pr—(NH)₂NH₂-MCM-41 containing Psf/PET supports were dipped into the n-hexane and TPC solution for 1 min. The unreacted TPC was washed using excess n-hexane. Finally, the resultant membranes were kept inside the oven at 80° C. for 1 hour for curing. Hence prepared polyamide active layers were denoted as PA/0.025-Pr-MCM, PA/0.05-Pr-MCM, PA/0.1-Pr-MCM, and corresponding membranes to PA/0.025-Pr-MCM@PSU/PET, PA/0.05-Pr-MCM@PSU/PET, PA/0.1-Pr-MCM@PSU/PET respectively, based on material loading. A schematic representation of different steps of membrane fabrication by incorporating Pr—(NH)₂NH₂-MCM-41 in the active layer is shown in FIG. 2.

### Example 5: Membrane Characterization

The Pr—(NH)₂NH₂-MCM-41 was synthesized using an in-situ simultaneous decoration of PrO and TMSPTA in the MCM-41 framework. The Pr—(NH)₂NH₂-MCM-41 material has unique features, such as large particle size and pore size, which can be attributed to the presence of three methoxyethoxide groups. The zeolite framework grows from three-OH groups of trivalent PrO compared to four sides of TEOS, leading to a relatively bigger pore size. Moreover, the amine groups present due to TMSPTA can act as ligands for binding with Pr transition metal, and on the other hand amino groups also take part in IP. The membranes were decorated through covalent crosslinking of Pr—(NH)₂NH₂-MCM-41 in the active layer of the membranes. Both primary and secondary amino groups of Pr—(NH)₂NH₂-MCM-41 are responsible for covalently bonding the Pr—(NH)₂NH₂-MCM-41 in the polyamide active layer of the membranes. The amide bonds are formed between acyl chloride groups of TPC and amino groups of Pr—(NH)₂NH₂-MCM-41 and tetra-amine. Hence, due to the chemical bonding between the amino groups and acyl chloride groups, Pr—(NH)₂NH₂-MCM-41 is covalently bonded in the membrane active layer. This stable incorporation of Pr—(NH)₂NH₂-MCM-41 in the active layer of the membranes is a highly desirable feature for membranes because Pr—(NH)₂NH₂-MCM-41 will remain stable during filtration experiments. The possible reaction between Pr—(NH)₂NH₂-MCM-41, TPC, and tetra-amine, along with the structure of the polyamide active layer, is given below in FIG. 3.

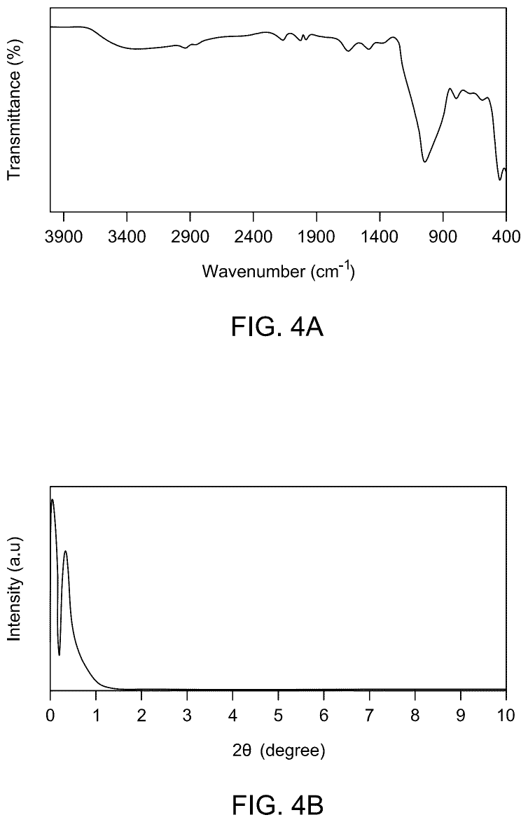

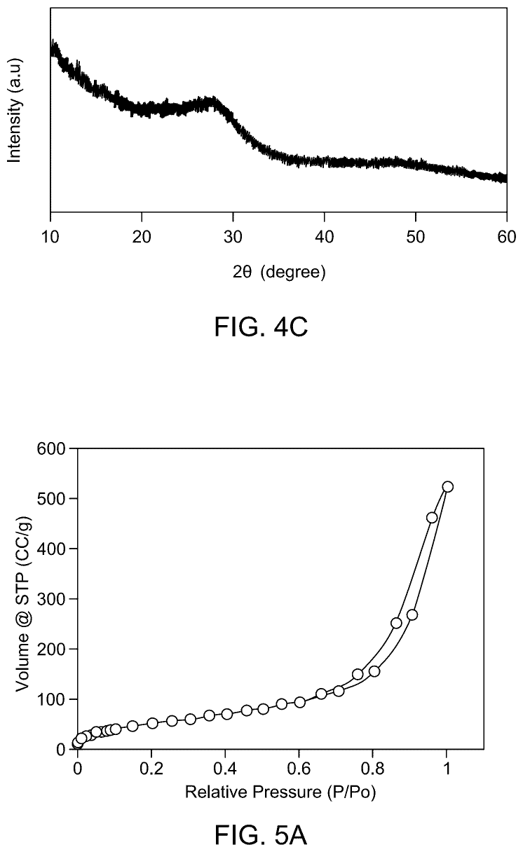

Following an in-situ covalent decoration of the Pr metal ions in the structure of MCM-41 with simultaneous amino-functionalization yielding Pr—(NH)₂NH₂-MCM-41, various relevant characterization techniques were applied for establishing the structure of Pr—(NH)₂NH₂-MCM-41. To find out various functionalities in the structure of Pr—(NH)₂NH₂-MCM-41, FTIR was carried out as shown in FIG. 4A. The presence of amino groups is confirmed by a broad band that spans from a region of 3600-centimeter inverse (cmⁿ⁻¹) to 3200 cm⁻¹. Similarly, the aliphatic-CH₂ groups of Pr—(NH)₂NH₂-MCM-41 are also confirmed by small peaks at 2900 cm⁻¹ and 2800 cm⁻¹. The deep band at 1400 cm⁻¹ is attributed to the O—Si—O bonds of MCM-41. Similarly, a weak band at around 500 cm⁻¹ is attributed to the Pr—O bond of the Pr—(NH)₂NH₂-MCM-41.

After identifying the various functionalities contributing to the structure of Pr—(NH)₂NH₂-MCM-41, the crystal structure of Pr—(NH)₂NH₂-MCM-41 was studied through low-angle and wide-angle PXRD of the Pr—(NH)₂NH₂-MCM-41 as shown in the following FIG. 4B and FIG. 4C. The low angle XRD revealed the presence of two highly sharp peaks in a region below 1°, which is a confirmation for the highly ordered structure of Pr—(NH)₂NH₂-MCM-41 indicating that the original structure of MCM-41 is intact even after the incorporation of transition metal Pr. The wide angle XRD also showed a typical XRD pattern of mesoporous silica MCM-41 with a hump located at 28°. Hence, the low-angle and wide-angle PXRD patterns confirmed the intactness of the mesoporous structure of the newly synthesized Pr—(NH)₂NH₂-MCM-41.

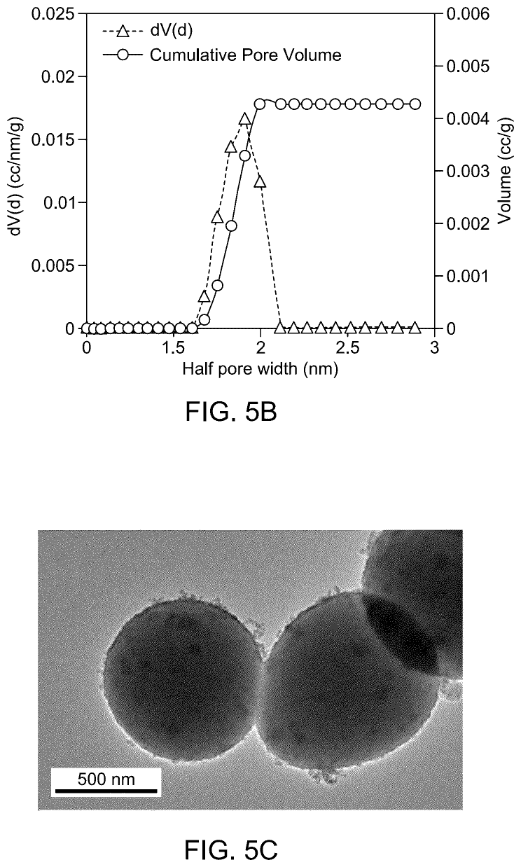

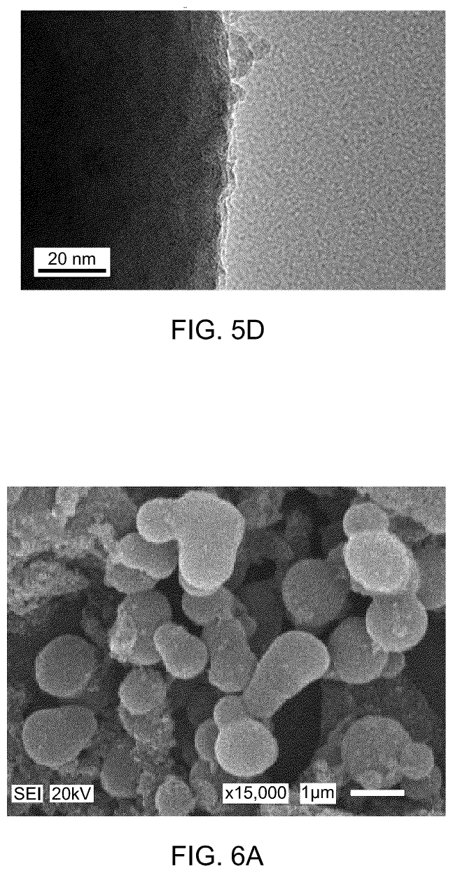

To get further evidence of the mesoporous nature of the newly synthesized Pr—(NH)₂NH₂-MCM-41, N₂ adsorption-desorption experiments were carried out, as shown in FIG. 5A and FIG. 5B. The mesoporous nature of Pr—(NH)₂NH₂-MCM-41 was confirmed from the type IV isotherm of N₂ adsorption-desorption data. This type of isotherm with hysteresis loop generally develops for mesoporous materials with pores size greater than a critical pore size. The capillary condensation happens at a considerably higher relative pressure P/Pₒ, which hinted at larger pore diameters as higher pressure of gases is required to saturate the pores completely (FIG. 5A). The pore diameter was estimated to be in the range of 3.0 nm to 4.0 nm as the half pore width was measured to be in the range of 1.5 nm to 2.0 nm (FIG. 5B). The surface area of the Pr—(NH)₂NH₂-MCM-41 was found to be 216 m² g⁻¹. The TEM images of Pr—(NH)₂NH₂-MCM-41 revealed highly ordered mesoporous spherical particles (FIG. 5C). The scale is shown in FIG. 5C indicates an approximate particle size ranging from 500 nm to 600 nm. The high-resolution TEM of Pr—(NH)₂NH₂-MCM-41 revealed uniform pore channels distributed throughout the structure of the Pr—(NH)₂NH₂-MCM-41 (FIG. 5D). The pore channels have diameters with a width of roughly 1 nm to 2 nm which agrees with the BET data.

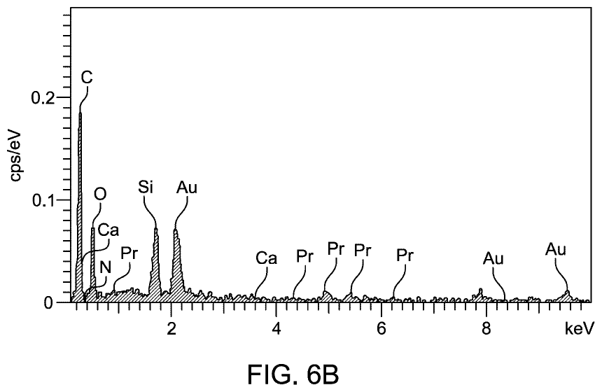

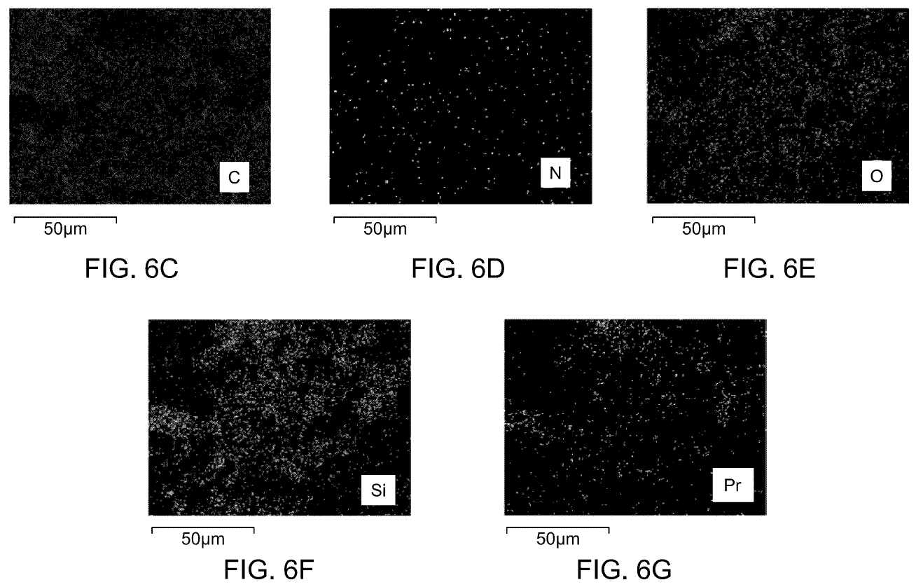

To ascertain the chemical composition of the Pr—(NH)₂NH₂-MCM-41, energy dispersive X-ray (EDX) and mapping analysis of Pr—(NH)₂NH₂-MCM-41 were carried out as shown in FIGS. 6A-6G. When a selected area of Pr—(NH)₂NH₂-MCM-41 (FIG. 6A) was analyzed through EDX, it revealed the presence of all the constituent elements in Pr—(NH)₂NH₂-MCM-41. The elements include carbon (C), oxygen (O), nitrogen (N), and, more importantly, silicon (Si) and praseodymium (Pr). The presence of C and O can be attributed to TEOS and praseodymium methoxyethoxide (PrOMeEtO), while N is due to TMSPTA. Similarly, Si is due to TEOS and TMSPTA silane groups, while Pr is due to PrOMeEtO. These results confirmed the contribution of all the constituent elements towards the structure of Pr—(NH)₂NH₂-MCM-41 (FIG. 6B). The mapping analysis confirmed the uniform distribution of all the detected elements in the structure of Pr—(NH)₂NH₂-MCM-41 (FIGS. 6C-6G). Another observation is the density of the elements in the Pr—(NH)₂NH₂-MCM-41, directly related to the concentration of elements in Pr—(NH)₂NH₂-MCM-41.

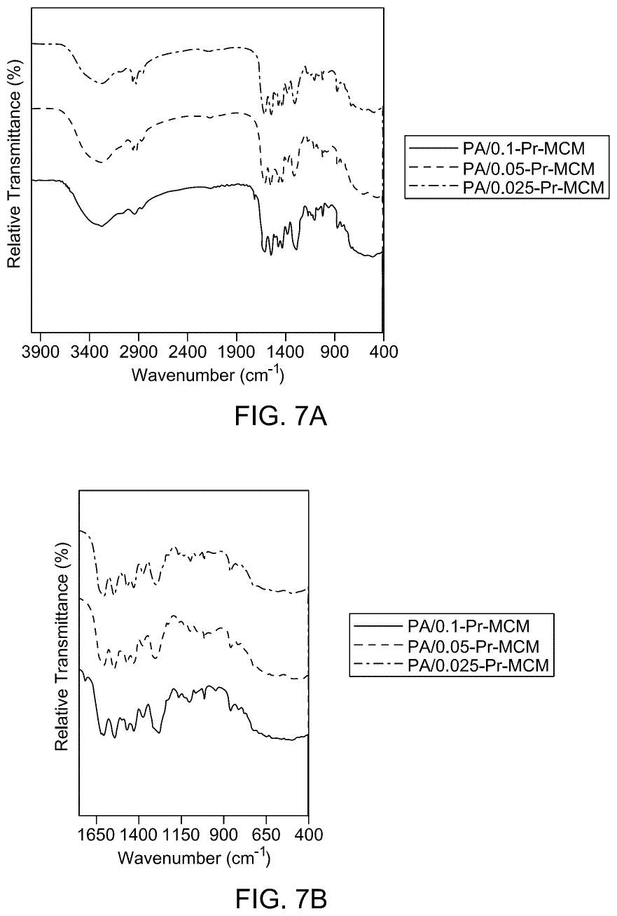

Free-standing active layers of the three different concentrations of Pr—(NH)₂NH₂-MCM-41 were synthesized to establish and characterize the structures of the Pr—(NH)₂NH₂-MCM-41 decorated membranes. FTIR analysis of free-standing active layers revealed the presence of several functional groups confirming the structure and functionalities of Pr—(NH)₂NH₂-MCM-41 membranes (FIG. 7A and FIG. 7B). As all the active layers are polyamides in nature, the presence of amide bond (—CONH) was realized by the presence of a broad band in a region of 3600 cm⁻¹ to 3200 cm⁻¹ which is a characteristic peak due to —N—H stretching of amide linkage. The amide bonds are generated due to the reaction of acid chloride (—COCl) of TPC with amine (—NH₂) groups of Pr—(NH)₂NH₂-MCM-41 and tetra-amine. The other peaks include aromatic —C—H bond stretching at around 3000 cm-1 due to benzene rings of TPC, —C—H bond stretching at 2900 cm⁻¹ and 2800 cm-⁻¹ due to aliphatic linear chains of tetra-amine and Pr—(NH)₂NH₂-MCM-41. Another confirmatory peak of amide linkage is the carbonyl (>C═O) peak located at 1650 cm⁻¹ Furthermore, a peak located at around 1300 cm⁻¹ to 1200 cm⁻¹ is due to O—Si—O of Pr—(NH)₂NH₂-MCM-41. All these findings and observations verified an effective contribution of all the reacting monomers leading to the covalent decoration of Pr—(NH)₂NH₂-MCM-41 in the active layers of the membranes.

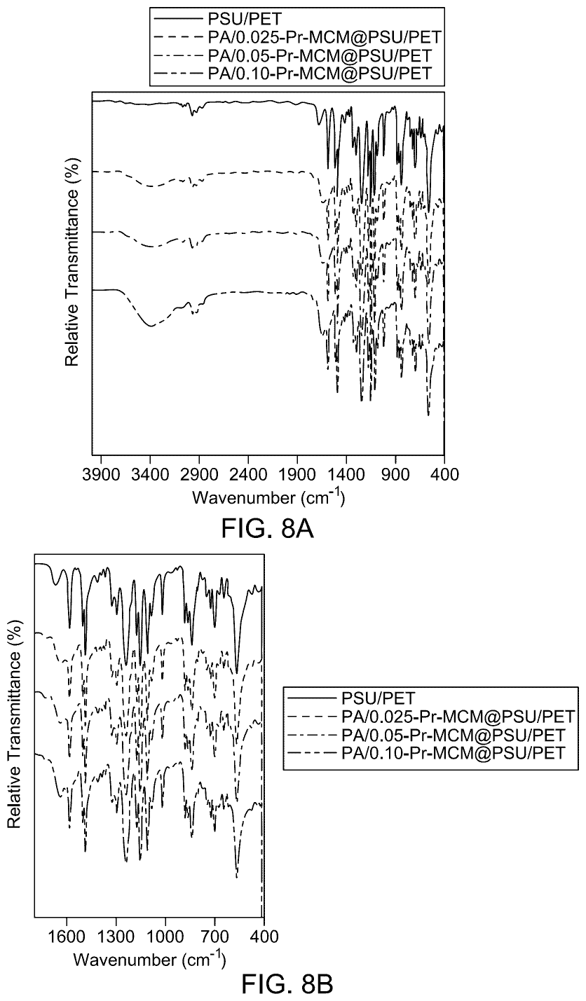

FIGS. 8A-8B show the ATR-FTIR spectra of all the TFC membranes compared to PSU/PET support. Appropriate and completely dried pieces of the support and fabricated membranes were scanned in ATR mode for recording the FTIR spectra. All the membranes with different concentrations of Pr—(NH)₂NH₂-MCM-41 showed the presence of all the peaks identified in the case of free-standing active layers, as shown in FIGS. 7A-7B. However, in the case of PSU/PET support, the region from 3600 cm⁻¹ to 3200 cm⁻¹ was found devoid of the broad amide peak as the PSU/PET support lacks the polyamide active layer (FIG. 8A and FIG. 8B).

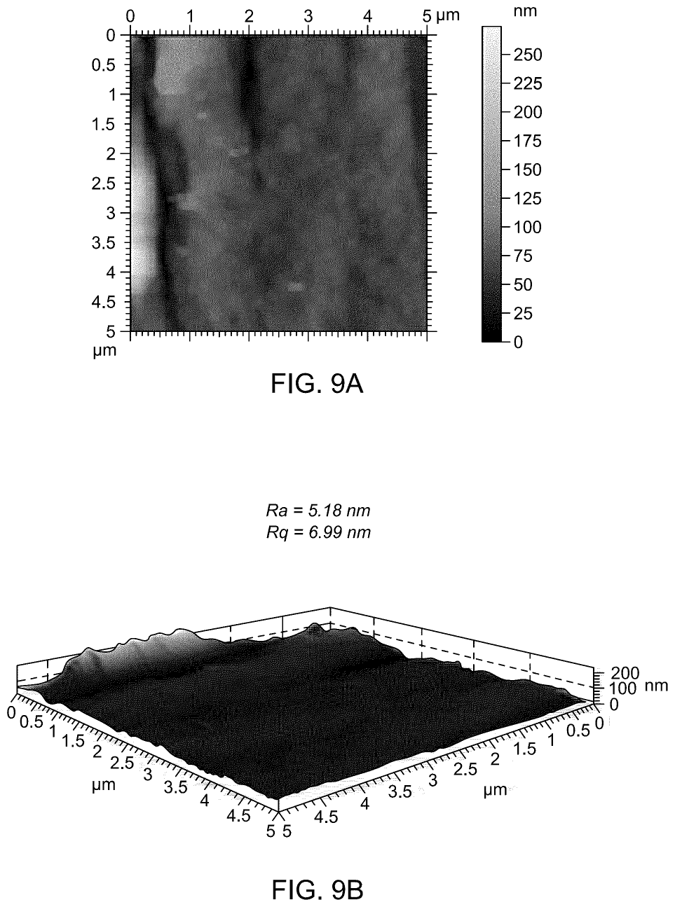

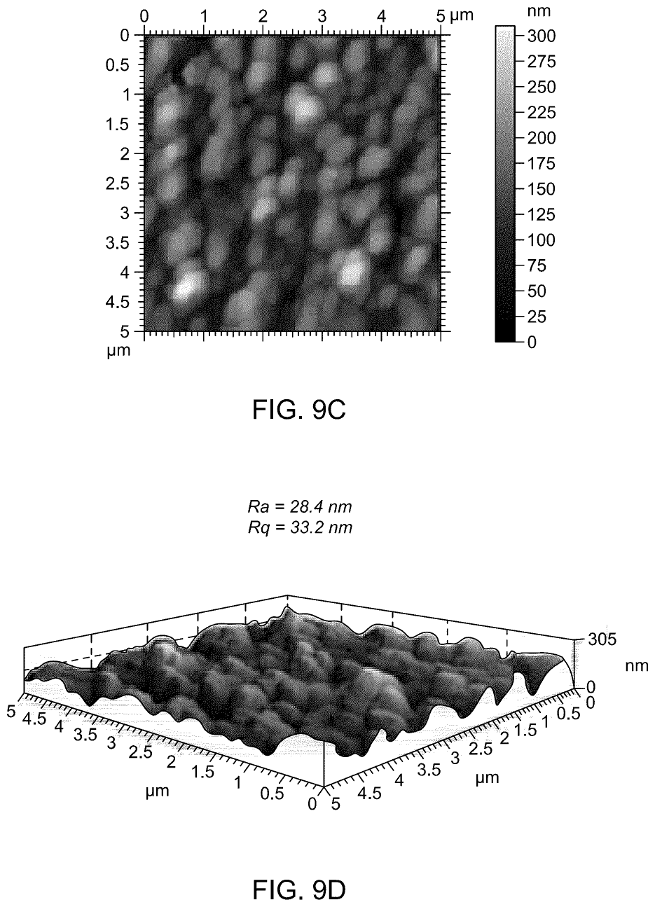

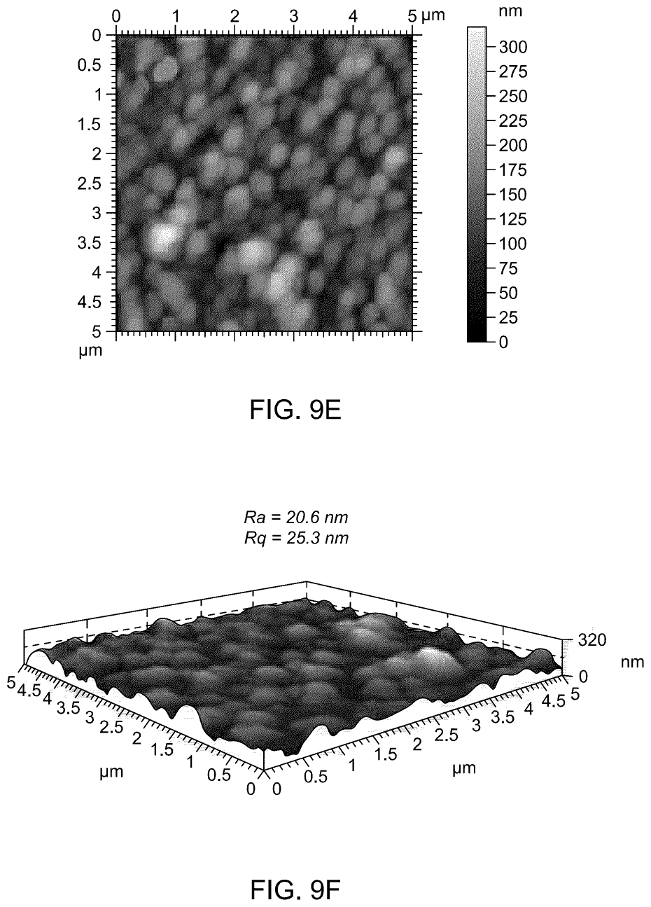

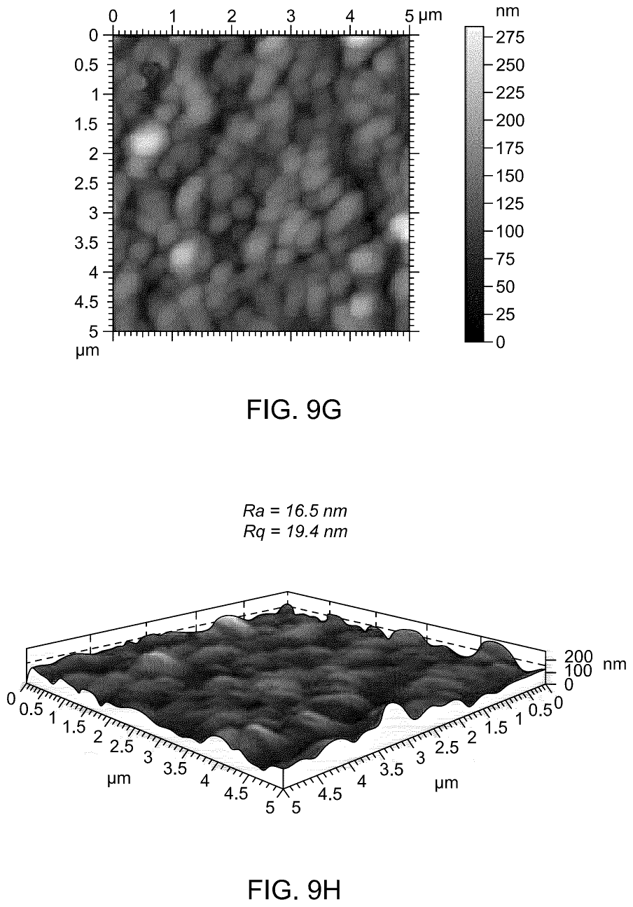

After establishing the chemical structure of Pr—(NH)₂NH₂-MCM-41 decorated membranes and PSU/PET support, various surface features of the support and membranes were also revealed by different characterization techniques. AFM of the support and Pr—(NH)₂NH₂-MCM-41 decorated membranes are given in FIGS. 9A-9H. AFM of the PSU/PET support (FIG. 9A and FIG. 9B) revealed a comparatively smoother surface compared to Pr—(NH)₂NH₂-MCM-41 decorated membranes. The smooth surface of PSU/PET support is attributed to the uniform and smooth deposition of a polysulfone dope solution using a doctor's blade on unwoven PET. After the IP reaction, the development of Pr—(NH)₂NH₂-MCM-41 decorated polyamide active layers resulted in forming a characteristic ridge and valley structure on the PSU/PET support. An analysis of both 2D and 3D AFM images led to the conclusion that the overall surface roughness of the Pr—(NH)₂NH₂-MCM-41 decorated membranes decreased with increasing concentration of Pr—(NH)₂NH₂-MCM-41. The highest surface average roughness (Rₐ) and mean square roughness (R_{q}) were found for PA/0.025-Pr-MCM@PSU/PET with Rₐ and R_{q} values of 28.4 nm and 33.2 nm, respectively (FIG. 9C and FIG. 9D). As the Pr—(NH)₂NH₂-MCM-41 concentration was raised to 0.05%, the Rₐ and R_{q} values decreased to 20.6 nm and 25.3 nm respectively (FIG. 9E and FIG. 9F). Finally, with a Pr—(NH)₂NH₂-MCM-41 concentration of 0.10% in case of PA/0.10-Pr-MCM@PSU/PET membrane the Rₐ and R_{q} values were decreased further to 16.5 nm and 19.4 nm (FIG. 9G and FIG. 9H). This trend can be attributed to the effective contribution of Pr—(NH)₂NH₂-MCM-41 in the crosslinking event of IP. The contribution of Pr—(NH)₂NH₂-MCM-41 in crosslinking leads to the filling of the valleys between the ridges of the polyamide beads, which can be seen in the 3D images of membranes as shown in FIG. 9D, FIG. 9F and FIG. 9H. The presence of amino groups in the structure of Pr—(NH)₂NH₂-MCM-41 made the covalent crosslinking of Pr—(NH)₂NH₂-MCM-41 in the active layer of the membranes.

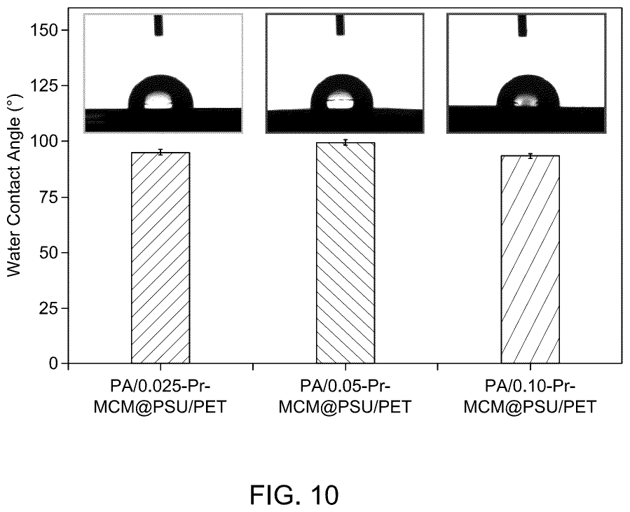

The water contact angle (WCA) measurement showed a value of 90°, consistent with several hand-cast polyamide membranes reported in the literature. These higher values of handmade polyamide membranes than commercial membranes are due to the rougher surface. Due to increased surface roughness of polyamide membranes, larger WCA contact angles are obtained than thought from the chemistry of the membrane, which is due to the entrapment of air bubbles between the solid surface rugosities and water droplets. It was observed that the WCA increased with increasing concentration of Pr—(NH)₂NH₂-MCM-41 in the active layer of the membrane as PA/0.025-Pr-MCM@PSU/PET and PA/0.050-Pr-MCM@PSU/PET have WCAs of 90° and 95°, respectively (FIG. 10). This increase in WCA shows that Pr—(NH)₂NH₂-MCM-41 is relatively less hydrophilic which might be due to the presence of silane groups in the structure of Pr—(NH)₂NH₂-MCM-41. However, in the case of PA/0.100-Pr-MCM@PSU/PET membrane, WCA was decreased to 85°. which might be due to smoother surface (Rₐ=16.5 nm) of PA/0.100-Pr-MCM@PSU/PET membrane compared to PA/0.025-Pr-MCM@PSU/PET (Rₐ=28.4 nm) and PA/0.050-Pr-MCM@PSU/PET (Rₐ=20.6 nm).

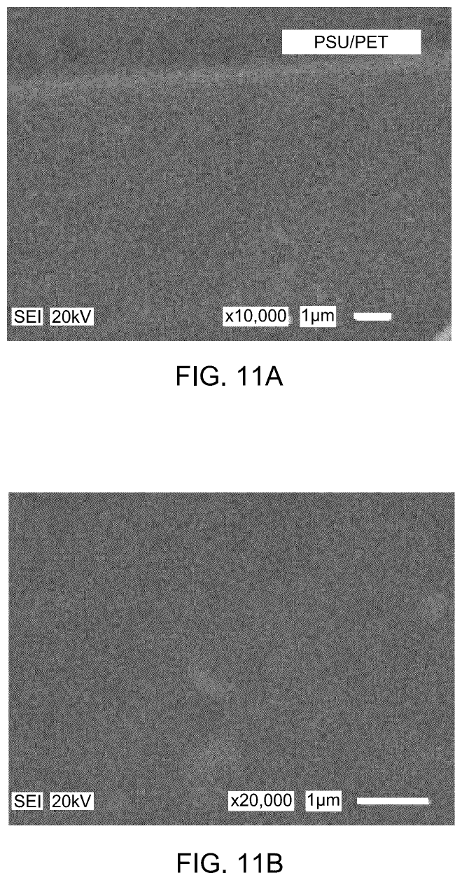

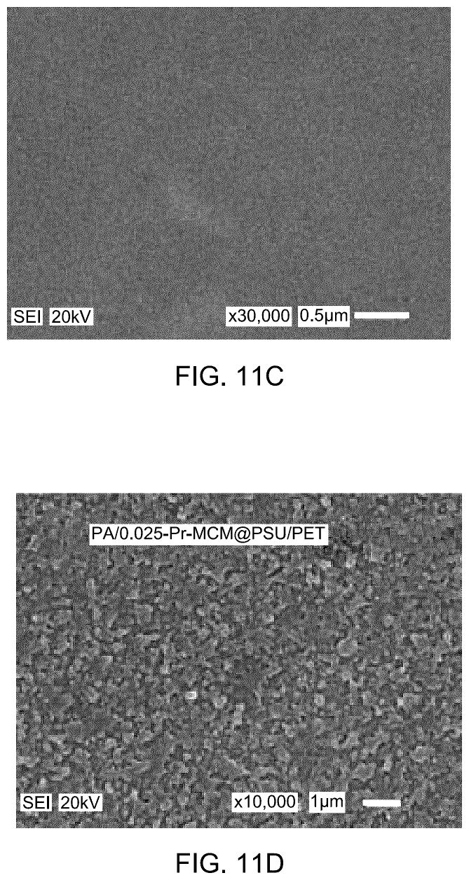

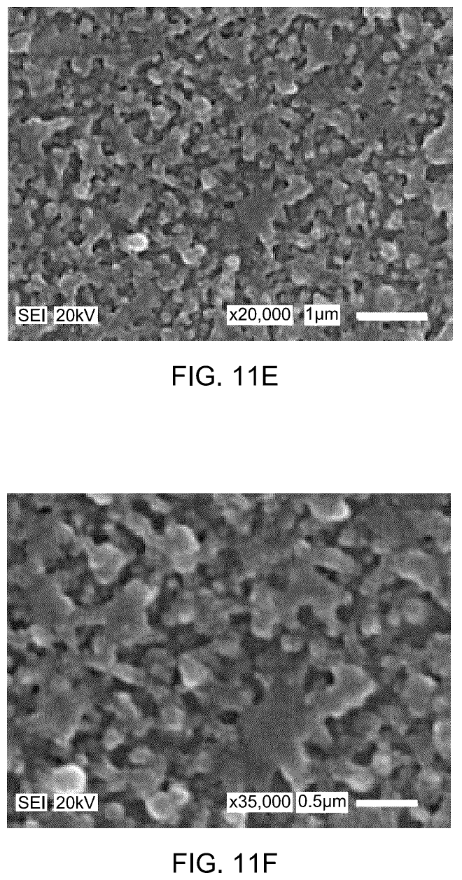

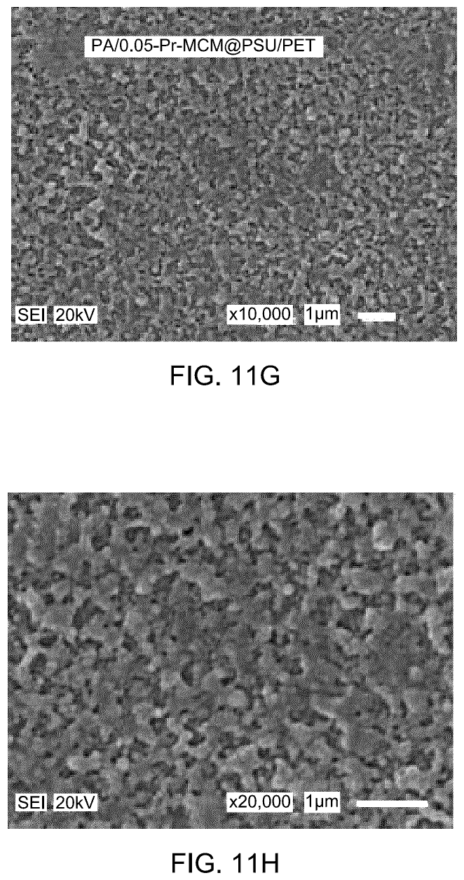

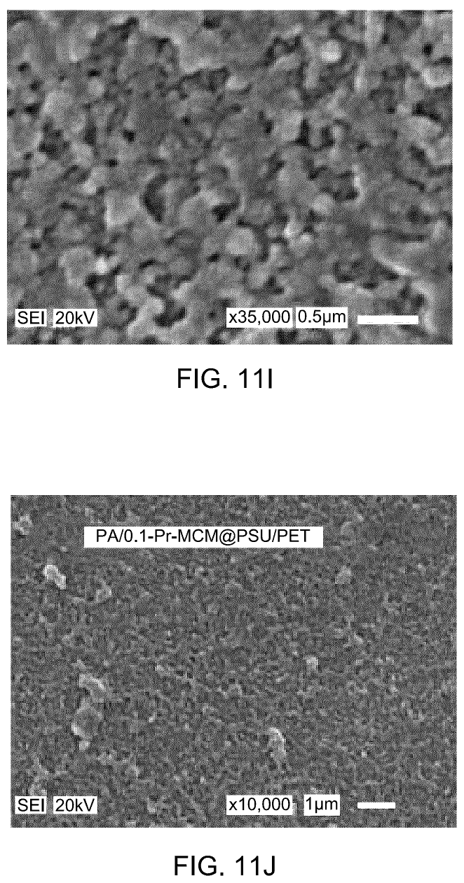

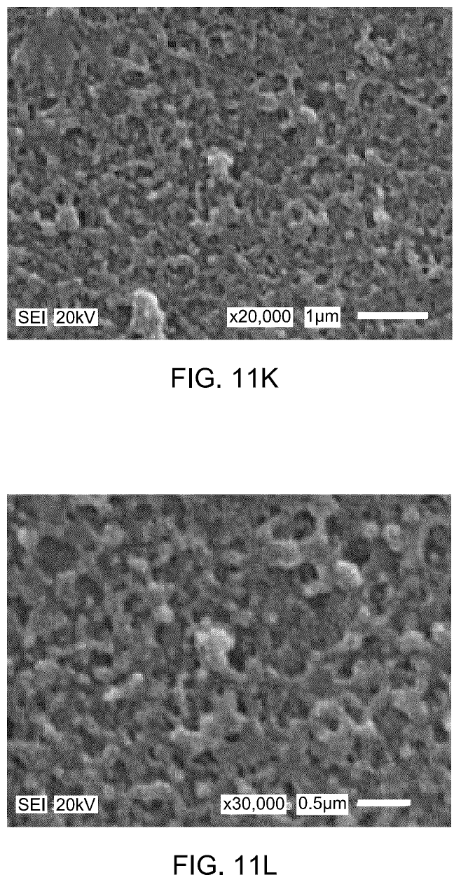

Like surface roughness and hydrophilicity of the membranes, surface morphology of the membranes is also a highly important feature of membranes. FIGS. 11A-11L show SEM micrographs of all the fabricated membranes, including PSU/PET support. FIGS. 11A-11C show the micrographs of PSU/PET support at different magnifications. The PSU/PET support appears highly porous and shows a uniform structure. This highly porous structure of PSU/PET support is due to the phase inversion process as the DMAc leaves the PSU and water replaces the DMAc leading to the development of pores in PSU/PET support. Unlike the PSU/PET support, the surface of the membranes appeared highly beaded, having a typical ridge and valley configuration. This ridge and valley morphology of the Pr—(NH)₂NH₂-MCM-41 membrane is attributed to the successful IP reaction between Pr—(NH)₂NH₂-MCM-41 containing aqueous amine solution and non-aqueous hexane solution of TPC.

Analysis of micrographs of Pr—(NH)₂NH₂-MCM-41 decorated membranes showed that with increasing concentration of Pr—(NH)₂NH₂-MCM-41, the valleys get filled with the polymeric mass, and the membrane surface becomes relatively smooth, as confirmed from AFM analysis of the membrane. FIG. 11F showed that PA/0.025-Pr-MCM@PSU/PET membrane has more vivid and clear valleys, while in the case of PA/0.050-Pr-MCM@PSU/PET membrane the ridges become slightly smoother (FIG. 111). Similarly, a smoother morphology is observed in case of PA/0.100-Pr-MCM@PSU/PET (FIG. 11L). The SEM micrographs of the Pr—(NH)₂NH₂-MCM-41 decorated membranes revealed the fact that Pr—(NH)₂NH₂-MCM-41 was impregnated entirely throughout the entire area of the membrane and no agglomeration of Pr—(NH)₂NH₂-MCM-41 was seen (FIGS. 11D-11L). This is due to the introduction of organic components such as TMSPTA, which made Pr—(NH)₂NH₂-MCM-41 familiar with the polymeric polyamide active layer. Given the unique features of Pr—(NH)₂NH₂-MCM-41, such as porosity, particle size, and surface area, the uniform decoration of Pr—(NH)₂NH₂-MCM-41 in the polyamide active layer provides the membranes with unique separation potential. Moreover, the ridge and valley confirmation of the membranes provides routes for water transport while rejecting the solutes.

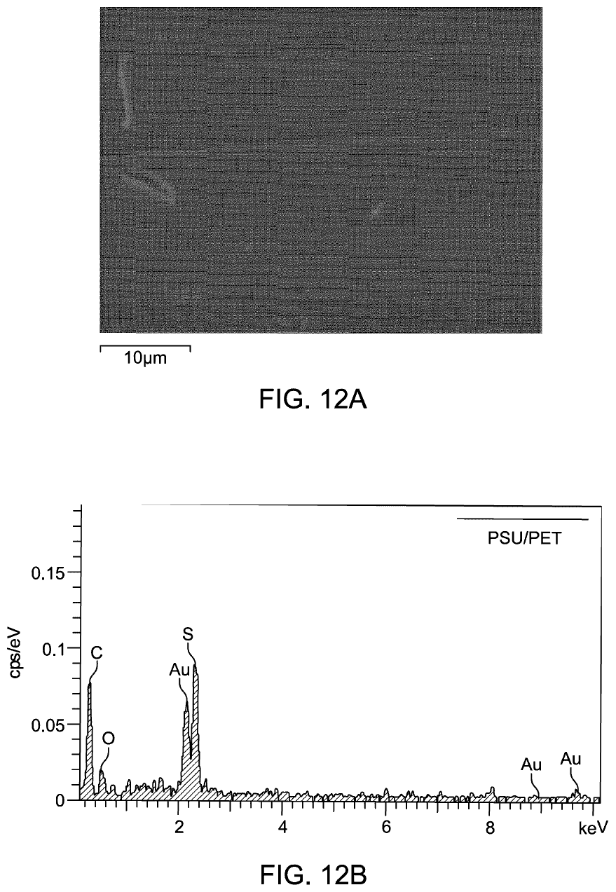

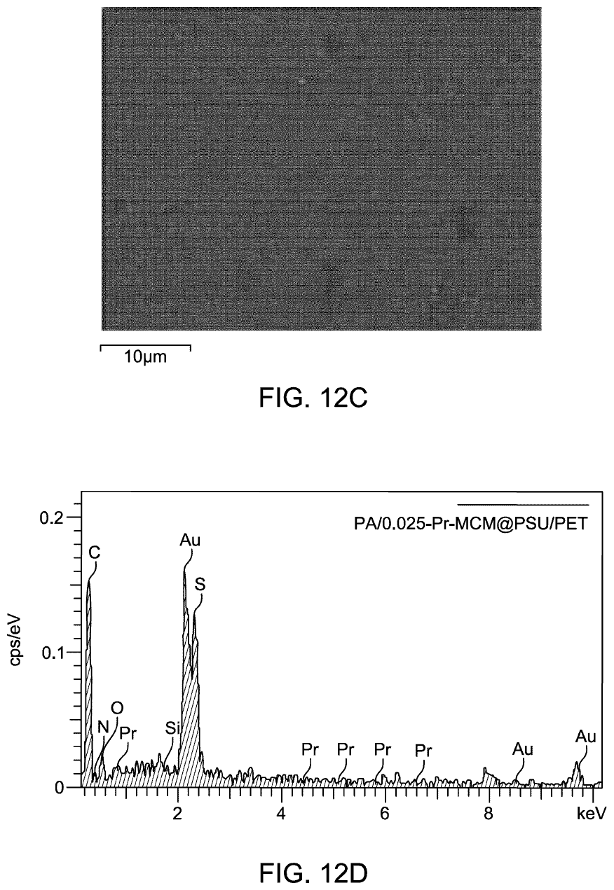

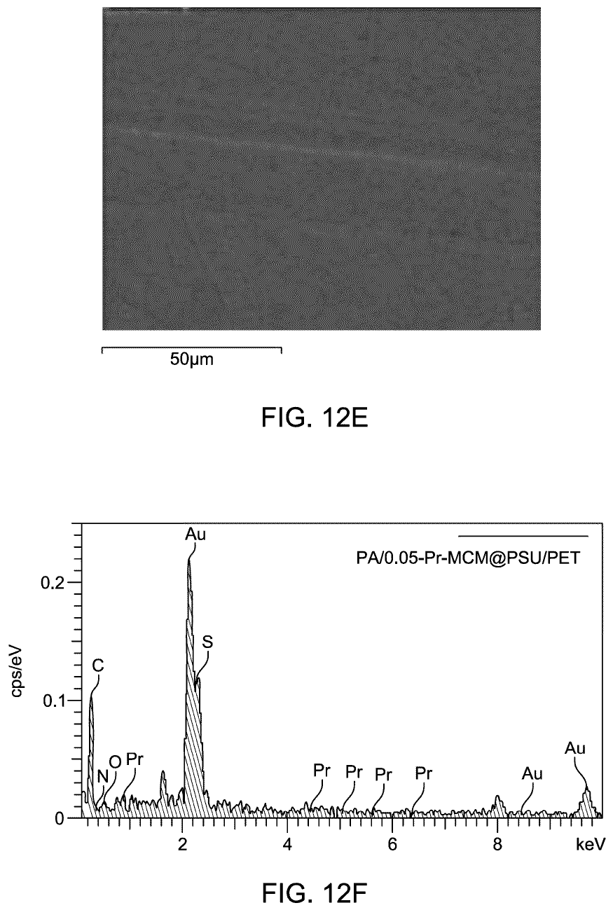

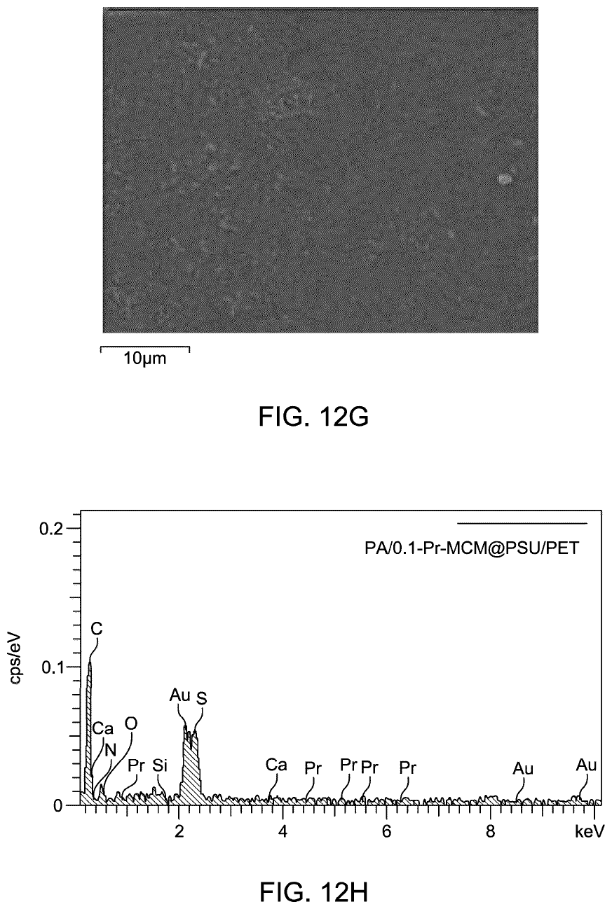

To further confirm the incorporation of Pr—(NH)₂NH₂-MCM-41 in the polyamide active layer of the TFC membranes, EDX analysis of the PUS/PET support and all the fabricated membranes was carried out as shown in the following FIGS. 12A-12H. EDX analysis of a selected area of PSU/PET support (FIG. 12A) confirmed the presence of carbon (C), sulfur (S), and oxygen (O) (FIG. 12B). However, EDX analysis of selected areas of Pr—(NH)₂NH₂-MCM-41 decorated membranes (FIG. 12C, FIG. 12E, and FIG. 12G) disclosed the presence of two additional elements nitrogen (N) and Praseodymium (Pr) which are due to the polyamide (—CONH) nitrogen atoms and Pr present in Pr—(NH)₂NH₂-MCM-41 (FIG. 12D, FIG. 12F and FIG. 12H). These observations confirmed the successful decoration of Pr—(NH)₂NH₂-MCM-41 in the polyamide active layer of the membranes.

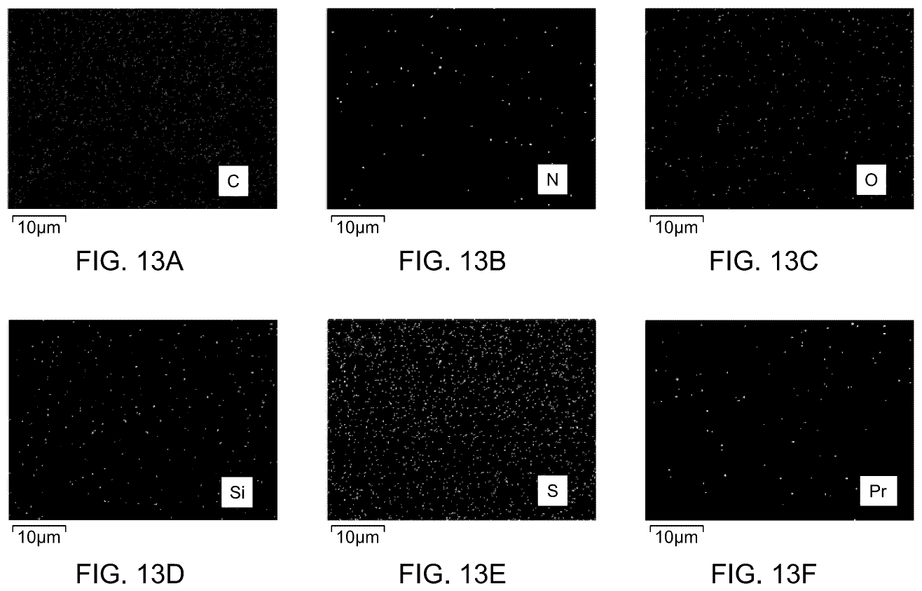

After confirming the presence of various essential elements in the active layer of the membranes, the distribution of all the elements in the active layer showed that all the identified elements were equally distributed throughout the entire area of the membranes (FIGS. 13A-13F).

The relative amount of all the elements in the membranes is reflected in the intensity of the dots in the images of the respected element. C (FIG. 13A) and S (FIG. 13E) are the most abundant elements, followed by O (FIG. 13C) and Si (FIG. 13D), while N (FIG. 13B) and Pr (FIG. 13F) are the least abundant elements, which agree with the molecular composition of membranes. These findings confirmed that the Pr—(NH)₂NH₂-MCM-41 were successfully decorated in the polyamide active layer of the membranes, where it has become an integral part of the membranes.

### Example 6: Membrane Performance

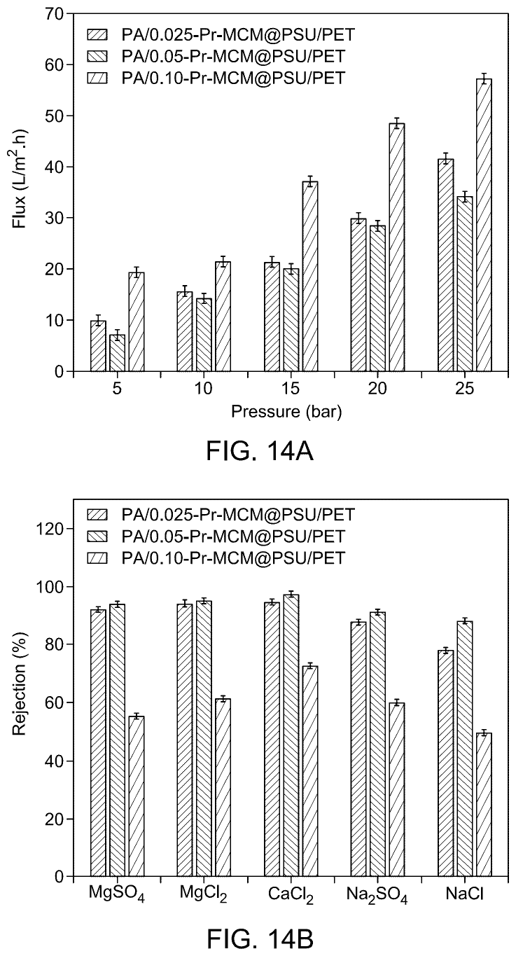

Following thorough characterization and establishing the structure of the membranes, the filtration performance of the Pr—(NH)₂NH₂-MCM-41 decorated membranes was evaluated. All three membranes were installed in parallel on a crossflow filtration system, and DI water was used as feed for compacting the membranes for 1 h at 20 bar. Following compaction, the membranes were tested for variation in the flux with increasing transmembrane pressure from 5 bar to 25 bar (FIGS. 14A-14B). It was observed that the permeate flux increased linearly with increasing transmembrane pressure, with flux reaching 56 L m⁻² h⁻¹ (LMH) at 25 bar for PA/0.050-Pr-MCM@PSU/PET membrane. Among the three tested membranes, the permeate flux showed variations to a certain extent, and following trend of increasing permeate flux was found PA/0.050-Pr-MCM@PSU/PET<PA/0.025-Pr-MCM@PSU/PET<PA/0.100-Pr-MCM@PSU/PET membrane. The permeate flux was found to be 33 LMH, 42 LMH, and 56 LMH at 25 bar for PA/0.050-Pr-MCM@PSU/PET, PA/0.025-Pr-MCM@PSU/PET and PA/0.100-Pr-MCM@PSU/PET respectively. This variation in permeate flux reflected that the amount of Pr—(NH)₂NH₂-MCM-41 decorated in the membrane active layer has affected the structure of the polyamide active layer.

These variations in membrane structure were detected during membrane characterization, such as in the SEM, AFM, and WCA. The 0.025 wt % led to an active layer with big-sized polyamide globules (FIG. 11F), while 0.100 wt % of Pr—(NH)₂NH₂-MCM-41 resulted in highly fine fibrous and porous active layers (FIG. 11L) of the membranes. These features could be responsible for higher flux in the case of PA/0.025-Pr-MCM @ PSU/PET and PA/0.100-Pr-MCM @ PSU/PET membranes. However, in the case of 0.05% wt % loading of Pr—(NH)₂NH₂-MCM-41 has generated a highly uniform and dense polyamide active layer which is responsible for lower permeate flux in the case of PA/0.050-Pr-MCM@PSU/PET membrane.

Similarly, the rejection performance of membranes was also tested by using both divalent (Mg²⁺, Ca²⁺and SO₄²⁻) and monovalent ions (Na⁺ and Cl⁻). By comparing the rejection performance of the fabricated membranes, it was found that higher concentrations of Pr—(NH)₂NH₂-MCM-41 were used in the active layers of the fabricated membranes. The PA/0.100-Pr-MCM@PSU/PET membrane showed the lowest rejection among all the three fabricated membranes, which can be understood by considering the structural features of PA/0.100-Pr-MCM@PSU/PET membrane. SEM micrographs and AFM analysis of the PA/0.100-Pr-MCM@PSU/PET membrane revealed an active layer having reduced ridge and valley configuration and the lowest surface roughness among all the membranes. Hence, PA/0.100-Pr-MCM@PSU/PET membrane offered the lowest mass transfer resistance to the salts and permeating water through the membrane. In the case of PA/0.100-Pr-MCM@PSU/PET membrane, the rejections of CaCl₂, MgCl₂, Na₂SO₄, MgSO₄ and NaCl were found to be 72%, 62%, 58%, 55%, and 48% respectively. The structure of Pr—(NH)₂NH₂-MCM-41 can also contribute to the decrease in the rejection of salts. Hence, higher concentrations of Pr—(NH)₂NH₂-MCM-41 are not ideal for enhancing the performance of the membranes, which might be due to the larger particle size and pore size of Pr—(NH)₂NH₂-MCM-41.

Therefore, the lower concentrations of Pr—(NH)₂NH₂-MCM-41 were found to be highly suitable for enhancing the flux of the membranes while maintaining relatively higher salt rejections. The rejection of salts by PA/0.05-Pr-MCM@PSU/PET membrane was found to be the highest among all the fabricated membranes, which were found to be 98%, 96%, 95%, 87%, and 82% for CaCl₂, MgCl₂, MgSO₄, Na₂SO₄, and NaCl, respectively. Similarly, the PA/0.025-Pr-MCM@PSU/PET membrane also showed a similar rejection of salts to that of the PA/0.05-Pr-MCM@PSU/PET membrane. The lower doses of Pr—(NH)₂NH₂-MCM-41 were found to be suitable for fabricating a desalination membrane with considerably acceptable salt rejection without lowering permeate flux to a larger extent. Hence, the salient features of Pr—(NH)₂NH₂-MCM-41, such as porosity, pore size, particle size, surface area, hydrophilicity, and compatibility with the polyamide active layer contribute to the enhanced performance of the desalination

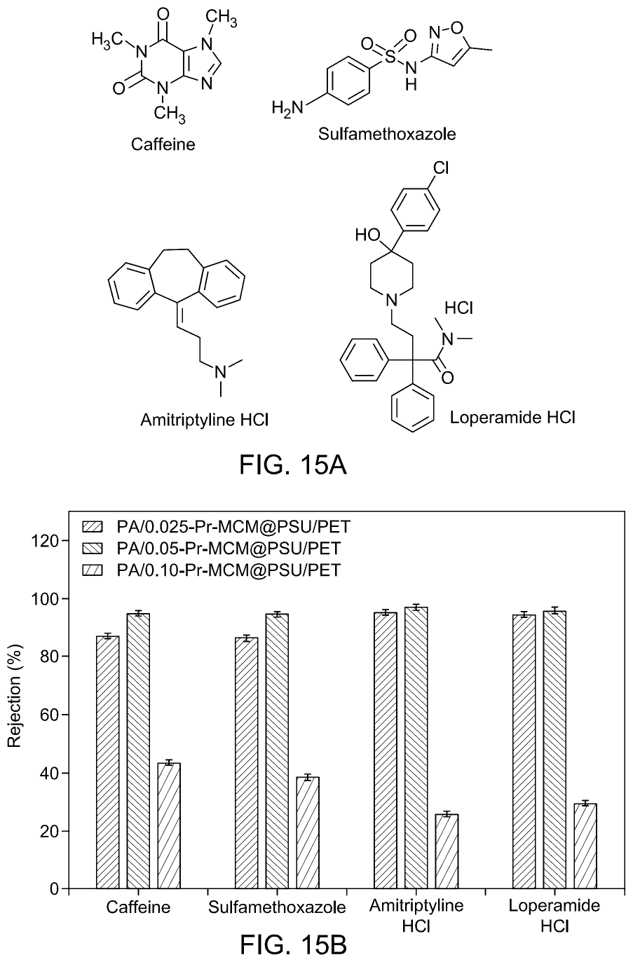

FIGS. 15A-15B show the rejection performance of the membranes by using different well-known pharmaceuticals as micropollutants in the feed. The micropollutants are continuously increasing in water bodies and hence require treatment before disposal as well as reuse of the contaminated water. All the pharmaceutical drugs (FIG. 15A) were found to be highly rejected >96% by PA/0.5-Pr-MCM-41@PSU/PET membrane followed by PA/0.025-Pr-MCM-41@PSU/PET membrane.

Numerous modifications and variations of the present disclosure are possible in light of the above teachings. It is, therefore, to be understood that within the scope of the appended claims, the invention may be practiced otherwise than as specifically described herein.

1. A membrane, comprising:
a support; and
an active layer,
wherein the active layer comprises reacted units of:
a functionalized mesoporous silica;
a first polyamine compound; and
a polyfunctional acid halide compound,
wherein a first portion of Si atoms in the functionalized mesoporous silica are replaced by Pr atoms,
wherein a second portion of the Si atoms in the functionalized mesoporous silica are functionalized with a second polyamine compound,
wherein the Pr atoms, the second portion of Si atoms functionalized with the second polyamine compound, and non-modified Si atoms in the functionalized mesoporous silica are covalently bonded in an alternating sequence, and
wherein the functionalized mesoporous silica, the first polyamine compound, and the polyfunctional acid halide compound are interfacially polymerized on the support to form the membrane.

2. The membrane of claim 1, wherein the functionalized mesoporous silica is in a form of spherical particles with an average diameter of 500-600 nanometers (nm).

3. The membrane of claim 1, wherein the functionalized mesoporous silica has an average pore channel diameter of 2-5 nm.

4. The membrane of claim 1, wherein the functionalized mesoporous silica has a surface area of 200-250 meter square per gram (m² g⁻¹).

5. The membrane of claim 1, wherein the functionalized mesoporous silica comprises C, Pr, N, O, and Si.

6. The membrane of claim 1, wherein 10-40% of the Si atoms are replaced by Pr, based on a total number of initial Si atoms in the functionalized mesoporous silica.

7. The membrane of claim 1, wherein 30-50% of the Si atoms are functionalized with the second polyamine compound, based on a total number of Si atoms in the functionalized mesoporous silica.

8. The membrane of claim 1, wherein the functionalized mesoporous silica is covalently bonded in the active layer, and
wherein a primary or secondary amino group of the second polyamine compound in the functionalized mesoporous silica covalently bonds to a first acid halide group of the polyfunctional acid halide compound in the interfacial polymerization thereby forming an amide bond.

9. The membrane of claim 8, wherein a second acid halide group of the polyfunctional acid halide compound covalently bonds to a primary or secondary amino group of the first polyamine compound in the interfacial polymerization thereby forming an amide bond.

10. The membrane of claim 1, wherein the functionalized mesoporous silica is distributed homogeneously over a surface of the active layer, and
wherein particles of the functionalized mesoporous silica are not agglomerated.

11. The membrane of claim 1, wherein the active layer has a ridge and valley morphology, and
wherein at least a portion of the valleys are filled with the functionalized mesoporous silica.

12. The membrane of claim 1, wherein the active layer comprises 0.01-1 wt. % of the functionalized mesoporous silica, based on total volume of an interfacial polymerization solution.

13. The membrane of claim 1, having a mean square roughness (Rq) of 15-35 nm.

14. The membrane of claim 1, having a water contact angle of 80-100°.

15. The membrane of claim 1, having a permeate flux of 30-60 liter square meter per hour (L m⁻² h⁻¹) (LMH) at 25 bar.

16. The membrane of claim 1, wherein the first and second polyamine compounds are the same or different and are selected from compounds having 3-7 amine groups.

17. The membrane of claim 1, wherein the polyfunctional acid halide compound is an aromatic compound with 2-3 acyl chloride groups.

18. The membrane of claim 1, wherein the mesoporous silica is MCM-41.

19. A method of removing a salt or an organic compound from an initial solution, comprising:
passing the initial solution through the membrane of claim 1 to form a filtered solution, wherein the filtered solution comprises at least 80% less of the salt or the organic compound than the initial solution.
